(19) United States
(12) Patent Application Publication
(10) Pub. No.: US 2018/0211096 A1
(43) Pub. Date: Jul. 26, 2018

(54) LIVING-BODY DETECTION METHOD AND DEVICE AND COMPUTER PROGRAM PRODUCT

(71) Applicants: BEIJING KUANGSHI TECHNOLOGY CO., LTD., Beijing (CN); MEGVII (BEIJING) TECHNOLOGY CO., LTD., Beijing (CN)

(72) Inventors: Zhimin CAO, Beijing (CN); Keqing CHEN, Beijing (CN); Kai JIA, Beijing (CN)

(21) Appl. No.: 15/738,500

(22) PCT Filed: Jun. 30, 2015
(86) PCT No.: PCT/CN2015/082815

§ 371 Date: Dec. 20, 2017

(51) Int. Cl. G06K 9/00

(52) U.S. Cl. CPC G06K 9/00255; G06K 9/00268; G06T 13/40; G06K 9/00335; G06K 9/00302

(57) ABSTRACT

Provided are a living-body detection method and device and a computer program product, belonging to the technical field of face recognition. The living-body detection method comprises: detecting a facial movement from a photograph image; according to said detected facial movement, controlling the display of a virtual object on a display screen; and, if said virtual object satisfies predetermined conditions, determining that the face in said photographed image is a living-body face. By controlling virtual-object display on the basis of face movements and performing living-body detection according to virtual-object display, it is possible to effectively prevent an attack using such means as photograph, video, 3D face model, or face mask.

### TECHNICAL FIELD

The present disclosure relates to the technical field of face recognition, and more particularly, to a living body detection method, a living body detection apparatus, and a computer program product.

### BACKGROUND

At present, face recognition systems are more and more applied to online scenarios that require ID authentication in fields like security, finance, social insurance etc., such as online bank account opening, online transaction operating verification, unmanned access control system, online social insurance transactions, online medical insurance transactions etc. In these application fields with high security level, in addition to ensuring that a face similarity of an authenticatee matches with library data stored in a database, first, it needs that the authenticatee is a legitimate biological living body. That is to say, the face recognition systems should be able to prevent an attacker from attacking using pictures, 3D face models, or masks, and so on.

The living body verification schemes acknowledged as mature do not exist among technology products on market, existing living body detection techniques either depend on special hardware devices (such as infrared camera, depth camera) or can prevent only simple attacks from static pictures.

Therefore, there is immense need for a face recognition manner not depending on special hardware devices but also capable of effectively preventing attacks using photos, videos, 3D face models, or masks, and so on.

### SUMMARY

In view of the above problem, the present disclosure is proposed. The embodiments of the present disclosure provide a living body detection method, a living body detection apparatus, and a computer program product, which are capable of controlling to display a virtual object based on a facial motion, and determining that living body detection is successful in a case where displaying of the virtual object satisfies a predetermined condition.

According to an aspect of the embodiments of the present disclosure, there is provided a living body detection method, comprising: detecting a facial motion from a captured image; controlling to display a virtual object on a display screen according to the detected facial motion; and determining that a face in the captured image is a face of a living body in a case where the virtual object satisfies a predetermined condition.

According to another aspect of the embodiments of the present disclosure, there is provided a living body detection apparatus, comprising: a facial motion detection device configured to detect a facial motion from a captured image; a virtual object control device configured to control to display a virtual object on a display screen according to the detected facial motion; and a living body determining device configured to determine that a face in the captured image is a face of a living body in a case where the virtual object satisfies a predetermined condition.

According to still another aspect of the embodiments of the present disclosure, there is provided a living body detection apparatus, comprising: one or more processors; one or more memories; and computer program instructions stored in the memories and configured to execute the following steps when being run by the processors: detecting a facial motion from a captured image; controlling to display a virtual object on a display device according to the detected facial motion; and determining that a face in the captured image is a face of a living body in a case where the virtual object satisfies a predetermined condition.

According to yet another aspect of the embodiments of the present disclosure, there is provided a computer program product, comprising one or more non-transitory computer readable mediums on which computer program instructions configured to execute the following steps when being run by a computer are stored: detecting a facial motion from a captured image; controlling to display a virtual object on a display device according to the detected facial motion; and determining that a face in the captured image is a face of a living body in a case where the virtual object satisfies a predetermined condition.

The living body detection method, the living body detection apparatus, and the computer program product according to the embodiments of the present disclosure can, by means of controlling to display the virtual object based on the facial motion and performing living body detection according to displaying of the virtual object, effectively prevent attacks using photos, videos, 3D face models, or masks, and so on, without depending on special hardware devices, thereby reduce the cost of living body detection. Further, a plurality of state parameters of the virtual object can be controlled by recognizing a plurality of motion attributes in the facial motion, so as to cause the virtual object to change a display state in multiple aspects, for example, causing the virtual object to perform a complicated predetermined motion, or causing the virtual object to achieve a display effect very different from an initial display effect. Therefore, the accuracy of living body detection can be further improved, thereby security in scenarios where the living body detection method, the living body detection apparatus, and the computer program product according to the embodiments of the present disclosure are applied can be further enhanced.

### BRIEF DESCRIPTION OF THE DRAWINGS

Through the more detailed descriptions of embodiments of the present disclosure that are provided with reference to the accompanying drawings, the above and other objectives, features, and advantages of the present disclosure will become more apparent. The drawings are to provide further understanding for the embodiments of the present disclosure and constitute a portion of the specification, and are intended to interpret the present disclosure together with the embodiments rather than to limit the present disclosure. In the drawings, the same reference sign generally refers to the same component or step.

FIG. 1 is a schematic block diagram of an electronic device for implementing a living body detection method and a living body detection apparatus according to an embodiment of the present disclosure;

FIG. 2 is a schematic flowchart of a living body detection method according to an embodiment of the present disclosure;

FIG. 3 is a schematic flowchart of a step of detecting a facial motion in a living body detection method according to an embodiment of the present disclosure;

FIG. 4 is a schematic flowchart of a step of controlling to display a virtual object in a living body detection method according to an embodiment of the present disclosure;

FIG. 5 is another schematic flowchart of a living body detection method according to an embodiment of the present disclosure;

FIGS. 6A to 6D and 7A to 7B are examples of virtual objects displayed on a display screen according to a first embodiment of the present disclosure;

FIGS. 8A and 8B are examples of virtual objects displayed on a display screen according to a second embodiment of the present disclosure;

FIGS. 9A to 9E are examples of virtual objects displayed on a display screen according to a third embodiment of the present disclosure;

FIGS. 10A to 10C are examples of virtual objects displayed on a display screen according to a fourth embodiment of the present disclosure;

FIG. 11 is a schematic block diagram of a living body detection apparatus according to an embodiment of the present disclosure;

FIG. 12 is a schematic block diagram of another living body detection apparatus according to an embodiment of the present disclosure;

FIG. 13 is a schematic block diagram of a facial motion detection device in a living body detection apparatus according to an embodiment of the present disclosure; and

FIG. 14 is a schematic block diagram of a virtual object control device in a living body detection apparatus according to an embodiment of the present disclosure.

### DETAILED DESCRIPTION OF THE EMBODIMENTS

To make the objectives, technical solutions, and advantages of the present disclosure more clear, exemplary embodiments of the present disclosure will be described in detail with reference to the accompanying drawings. Obviously, the described embodiments merely are part of the embodiments of the present disclosure, rather than all of the embodiments of the present disclosure, it should be understood that the present disclosure is not limited to the exemplary embodiments described herein. Other embodiments obtained by those skilled in the art without paying inventive efforts should all fall into the protection scope of the present disclosure.

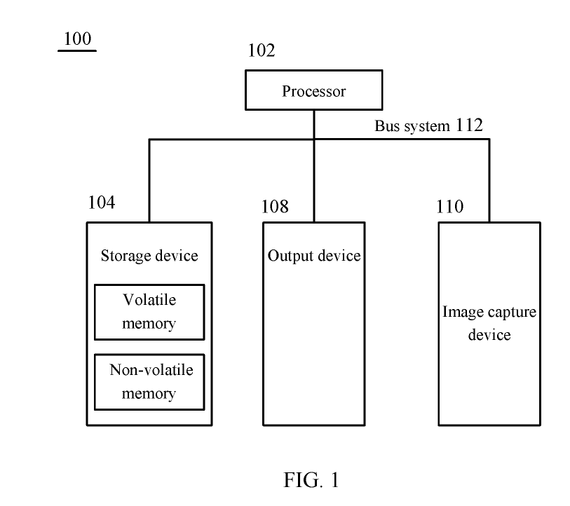

First, an exemplary electronic device 100 for implementing a living body detection method and a living body detection apparatus according to the embodiments of the present disclosure is described with reference to FIG. 1.

As shown in FIG. 1, the electronic device 100 comprises one or more processors 102, one or more storage devices 104, an output device 108, and an image capture device 110, these components are interconnected via a bus system 112 and/or other forms of connection mechanism (not shown). It should be noted that the components and structure of the electronic device 100 shown in FIG. 1 are merely exemplary, rather than restrictive, the electronic device 100 may also have other components and structure as desired.

The processor 102 may be a central processing unit (CPU) or other forms of processing unit having data processing capability and/or instruction executing capability and also capable of controlling other components in the electronic device 100 to execute intended functions.

The storage device 104 may include one or more computer program products, the computer program product may include various forms of computer readable storage medium, such as volatile memory and/or non-volatile memory. The volatile memory may include, for example, random access memory (RAM) and/or cache. The non-volatile memory may include, for example, read only memory (ROM), hard disk, flash memory. One or more computer program instructions may be stored on the computer readable storage medium, and the processor 102 can run the program instructions to achieve the functions and/or other intended functions in the embodiments (implemented by the processor) of the present disclosure as described below. Various applications and various data may be also stored in the computer readable storage medium, for example, image data as acquired by the image capture device 110, various data used by and/or produced by the application, or the like.

The output device 108 may output various information (e.g., image or sound) to outside (e.g., a user), and may include one or more of a display and a speaker, or the like.

The image capture device 110 may capture an image (e.g., photo, video etc.) within a predetermined framing coverage and store the captured image in the storage device 104 for use by other components.

As an example, the exemplary electronic device 100 for implementing the living body detection method and the living body detection apparatus according to the embodiments of the present disclosure may be an electronic device integrated with a facial image capture device and disposed at a facial image capture terminal, such as a smart phone, a tablet, a personal computer, an ID recognition device based on face recognition, or the like. For example, in the application field of security, the electronic device 100 may be deployed at an image capture terminal of an access control system and may, for example, be a face recognition-based ID recognition device; in the application field of finance, it may be deployed at a personal terminal, such as a smart phone, a tablet, a personal computer, or the like.

Alternatively, the output device 108 and the image capture device 110 of the exemplary electronic device 100 for implementing the living body detection method and the living body detection apparatus according to the embodiments of the present disclosure may be deployed at a facial image capture terminal, whereas the processor 102 in the electronic device 100 may be deployed at a server terminal (or in the cloud).

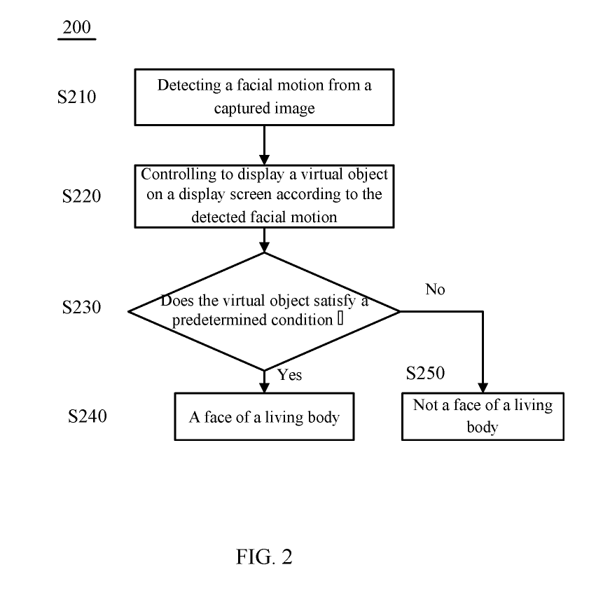

Next, a face detection method 200 according to an embodiment of the present disclosure is described with reference to FIG. 2.

In step S210, a facial motion is detected from a captured image. Specifically, the image capture device 110 in the electronic device 100 for implementing the face detection method according to an embodiment of the present disclosure as shown in FIG. 1 or other image capture devices independent of the electronic device 100 but capable of transmitting images to the electronic device 100 may be used to capture a grayscale or chromatic image within a predetermined shooting range as the captured image, the captured image may be a photo or one frame in a video. The image capture device may be a camera of a smart phone, a camera of a tablet, a camera of a personal computer, or even a webcam.

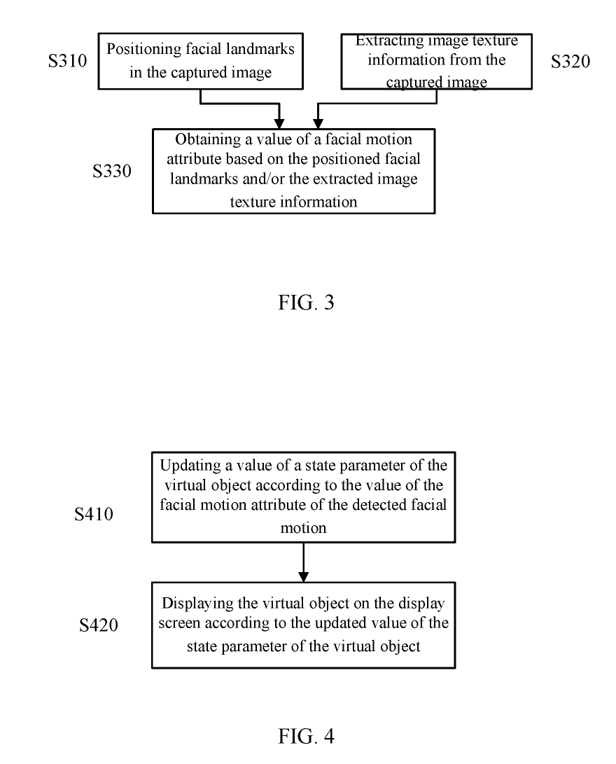

The facial motion detection in step S210 is described with reference to FIG. 3.

In step S310, facial landmarks are positioned in the captured image. As an example, in this step, it may be determined first whether a face is included in the captured image, and facial landmarks are positioned if a face has been detected.

Facial landmarks are some key points with high representational competence on the face, such as eyes, corners of eyes, eye centers, eyebrows, peak-points of cheekbones, nose, nose tip, nose wing, mouth, corners of mouth, and face contour points.

As an example, a large number of facial images, such as N facial images, may be collected in advance, for example, N=10000, and a predetermined series of facial landmarks are manually marked in each facial image, and the predetermined series of facial landmarks may include, but not limited to, at least part of the facial landmarks described above. Facial landmark model training is performed according to shape features near the respective facial landmarks in each facial image, based on parametric shape models, and using machine learning algorithms (such as deep learning, or local feature-based regression algorithm), thus obtaining a facial landmark model.

Specifically, in step S310, face detection and facial landmark positioning may be performed in the captured image based on an already-established facial landmark model. For example, positions of facial landmarks may be iteratively optimized in the captured image, and finally coordinate positions of the respective facial landmarks are obtained. As another example, a cascaded-regression-based method may be adopted to position facial landmarks in the captured image.

Positioning of facial landmarks plays an important role in face recognition, however, it should be understood that the present disclosure is not limited to the specific facial landmark positioning method adopted herein. The existing face detection and facial landmark positioning algorithms may be adopted to perform facial landmark positioning in step S310. It should be understood that the living body detection method 100 according to an embodiment of the present disclosure is not limited to facial landmark positioning performed by using the existing face detection and facial landmark positioning algorithms, and should cover facial landmark positioning performed by using face detection and facial landmark positioning algorithms to be developed in the future.

In step S320, image texture information is extracted from the captured image. As an example, fine-grained facial information, such as eyeball position information, mouth shape information, micro facial expression information, or the like, may be extracted according to pixel information in the captured image, such as luminance information of pixel dots. The existing image texture information extraction algorithms may be adopted to perform image texture information extraction in step S320. It should be understood that the living body detection method 100 according to an embodiment of the present disclosure is not limited to image texture information extraction performed by using the existing image texture information extraction algorithms and should cover image texture information extraction performed by using image texture information extraction algorithms to be developed in the future.

It should be understood that steps S310 and S320 may be executed alternatively, or may be both executed. In a case where steps S310 and S320 are both executed, they may be executed synchronously or in sequence.

In step S330, a value of a facial motion attribute is obtained based on the positioned facial landmarks and/or the image texture information. The facial motion attribute obtained based on the positioned facial landmarks may, for example, include, but not limited to, a degree of eye opening and closing, a degree of mouth opening and closing, a degree of face tilting, a degree of face deflection, a distance between face and camera, or the like. The facial motion attribute obtained based on the image texture information may include, but not limited to, a degree of leftward and rightward eyeball rotation, a degree of upward and downward eyeball rotation, or the like.

Optionally, the value of the facial motion attribute may be obtained based on a currently captured image and one image captured previously to the currently captured image; alternatively, the value of the facial motion attribute may be obtained based on a first captured image and a currently captured image; alternatively, the value of the facial motion attribute may be obtained based on a currently captured image and a few images captured previously to the currently captured image.

Optionally, the value of the facial motion attribute may be obtained based on the positioned facial landmarks by means of geometric learning, machine learning, or image processing. For example, as for the degree of eye opening and closing, multiple landmarks may be defined in a circle around the eyes, such as 8 to 20 landmarks, for example, inter corner of the left eye, outer corner of the left eye, upper eyelid center of the left eye, lower eyelid center of the left eye, inter corner of the right eye, outer corner of the right eye, upper eyelid center of the right eye, and lower eyelid center of the right eye. Then, these landmarks are positioned on the captured image, coordinates of these landmarks on the captured image are determined, a distance between the upper eyelid center and the lower eyelid center of the left eye (right eye) is calculated as an eyelid distance of the left eye (right eye), a distance between the inner corner and the outer corner of the left eye (right eye) is calculated as a canthus distance the left eye (right eye), a ratio of the inner-outer corner distance of the left eye (right eye) to the canthus distance the left eye (right eye) is calculated as a first distance ratio X. A degree Y of eye opening and closing is determined based on the first distance ratio X. For example, a threshold Xmax of the first distance ratio X may be set, and it may be prescribed that Y=X/Xmax, so as to determine the degree Y of eye opening and closing. A larger Y represents that the user's eye opens larger.

Returning to FIG. 2, in step S220, a virtual object is controlled to display on a display screen according to the detected facial motion.

As an example, a state of the virtual object displayed on the display screen may be controlled to change according to the detected facial motion. In this case, the virtual object may include a first group of objects, the first group of objects has been displayed on the display screen in an initial state and may include one or more objects. In this example, displaying of at least one object in the first group of objects on the display screen is updated according to the detected facial motion. An initial display position and/or an initial display form of at least part of objects in the first group of objects is predetermined or randomly determined. Specifically, for example, a motion state, a display position, a size, a shape, a color, or the like of the virtual object may be changed.

Optionally, a new virtual object may be controlled to display on the display screen according to the detected facial motion. In this case, the virtual object may further include a second group of objects, the second group of objects has not been displayed on the display screen in an initial state and may include one or more objects. In this example, at least one object in the second group of objects is displayed according to the detected facial motion. An initial display position and/or an initial display form of at least a portion of at least one object in the second group of objects is predetermined or randomly determined.

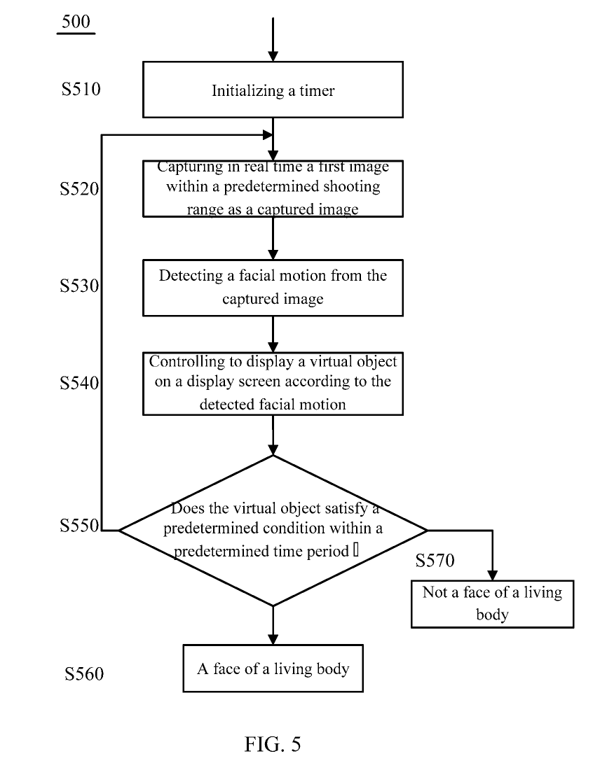

The operation in step S220 is described with reference to FIG. 4.

In step S410, a value of a state parameter of the virtual object is updated according to the value of the facial motion attribute.

Specifically, one facial motion attribute may be mapped as one state parameter of the virtual object. For example, the degree of eye opening and closing or the degree of mouth opening and closing of the user may be mapped as the size of the virtual object, and the size of the virtual object may be updated according to a value of the degree of eye opening and closing or a value of the degree of mouth opening and closing of the user. Another example, the degree of face tilting of the user may be mapped as a vertical display position of the virtual object on the display screen, and the vertical display position of the virtual object on the display screen is updated according to a value of the degree of face tilting of the user.

Alternatively, a ratio K1 of the degree of mouth opening and closing in the currently captured image to the degree of mouth opening and closing in the first captured image as previously captured may be calculated, and the ratio K1 of the degree of mouth opening and closing may be mapped as the size S of the virtual object. Specifically, mapping may be implemented using a linear function S=a*K1+b. In addition, optionally, a degree K2 of how far a face position in a currently captured image deviates from an initial centered position may be calculated, and the face position may be mapped as the position W of the virtual object. Specifically, mapping may be implemented using a linear function W=c*K2+d.

For example, the facial motion attribute may include at least one motion attribute, and the state parameter of the virtual object includes at least one state parameter. One motion attribute may correspond to only one state parameter, or one motion attribute may correspond to a plurality of state parameters in a chronological order.

Optionally, mapping relationship between the facial motion attribute and the state parameter of the virtual object may be preset, or may be randomly determined when starting to execute the living body detection method according to an embodiment of the present disclosure. The living body detection method according to an embodiment of the present disclosure may further comprise: prompting mapping relationship between the facial motion attribute and the state parameter of the virtual object to the user.

In step S420, the virtual object is displayed on the display screen according to the updated value of the state parameter of the virtual object.

As described above, the virtual object may include a first group of objects, the first group of objects is displayed on the display screen when starting to execute the living body detection method according to an embodiment of the present disclosure. Displaying of at least one object in the first group of objects may be updated through a first group of facial motion attributes. In addition, the virtual object may further include a second group of objects, none of objects in the second group of objects has been displayed on the display screen when starting to execute the living body detection method according to an embodiment of the present disclosure. Whether to display at least one object in the second group of objects may be controlled through a second group of facial motion attributes different from the first group of facial motion attributes; or, whether to display at least one object in the second group of objects may be controlled according to display situation of the first group of objects.

Specifically, the state parameter of at least one object in the first group of objects may be a display position, a size, a shape, a color, a motion state, or the like, so that the motion state, the display position, the size, the shape, the color, or the like of at least one object in the first group of objects may be changed according to values in a first group of facial motion attributes.

Optionally, the state parameter of each of at least one object in the second group of objects may include at least a visible state, and may further include a display position, a size, a shape, a color, a motion state, or the like. Whether to display at least one object in the second group of objects, i.e., whether at least one object in the second group of objects is in a visible state, may be controlled through values in a second group of facial motion attributes or according to display situation of at least one object in the first group of objects; and the motion state, the display position, the size, the shape, the color, or the like of at least one object in the second group of objects may be changed according to values in the second group of facial motion attributes and/or values in the first group of facial motion attributes.

Returning to FIG. 2, in step S230, it is determined whether the virtual object satisfies a predetermined condition. The predetermined condition is a condition related to a form and/or a motion of the virtual object, wherein the predetermined condition is predetermined or randomly generated.

Specifically, it may be determined whether the form of the virtual object satisfies a form-related condition. For example, the form of the virtual object may include a size, a shape, a color, or the like; and it may be determined whether a motion-related parameter of the virtual object satisfies a motion-related condition, for example, the motion-related parameter of the virtual object may include a position, a motion trajectory, a motion speed, a motion direction, or the like, and the motion-related condition may include a predetermined display position of the virtual object, a predetermined motion trajectory of the virtual object, a predetermined display position that the display position of the virtual object needs to be avoided from, or the like. It may be determined whether the virtual object has completed a predetermined task according to an actual motion trajectory of the virtual object. The predetermined task may include, for example, moving along a predetermined motion trajectory, moving around an obstacle, or the like.

Specifically, for example, in a case where the virtual object includes a first group of objects and the first group of objects includes a first object, the predetermined condition may be set as that the first object reaches a target display position, the first object reaches a target display size, the first object reaches a target shape, and/or the first object reaches a target display color, and so on.

Optionally, the first group of objects further includes a second object, an initial display position and/or an initial display form of at least one of the first object and the second object is predetermined or randomly determined. As an example, the first object may be a controlled object, the second object may be a background object, and optionally, the second object may be a target object of the first object, and the predetermined condition may be set as that the first object coincides with the target object. Alternatively, the background object may be a target motion trajectory of the first object, the target motion trajectory may be randomly generated, the predetermined condition may be set as that an actual motion trajectory of the first object coincides with the target motion trajectory. Alternatively, the background object may be an obstacle object, the obstacle object may be randomly displayed, its display position and display time are both random, and the predetermined condition may be set as that the first object does not meet the obstacle object, i.e. the first object bypasses the obstacle object.

Another example, in a case where the virtual object further includes a second group of objects and the second group of objects includes a third object as a controlled object, the predetermined condition may further be set as that the first and/or the third object reaches the corresponding target display position, the first and/or the third object reaches the corresponding target display size, the first and/or the third object reaches the corresponding target shape, and/or the first and/or the third object reaches the corresponding target display color, and so on.

In a case where the virtual object satisfies the predetermined condition, it is determined in step S240 that the face in the captured image is a face of a living body. Conversely, in a case where the virtual object does not satisfy the predetermined condition, it is determined in step S250 that the face in the captured image is not a face of a living body.

The living body detection method according to an embodiment of the present disclosure can, by means of taking various facial motion parameters as state control parameters of the virtual object, and controlling to display the virtual object on the display screen according to the facial motion, perform living body detection according to whether the displayed virtual object satisfies the predetermined condition.

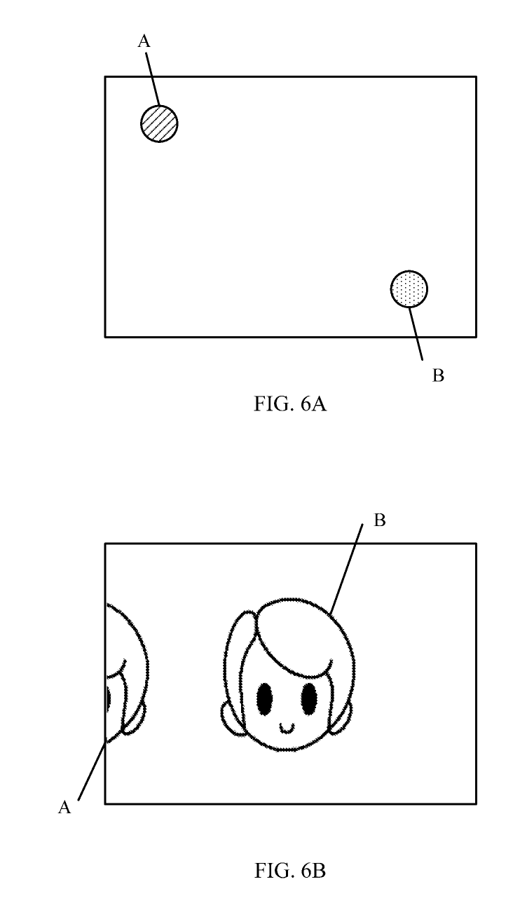

FIG. 5 shows an exemplary flowchart of another living body detection method 500 according to an embodiment of the present disclosure.

In step S510, a timer is initialized. The timer may be initialized according to a user input, or may be automatically initialized when a face has been detected in the captured image, or may be automatically initialized when a predetermined facial motion has been detected in the captured image. In addition, at least a portion of each object in the first group of objects is displayed on the display screen after the timer is initialized.

In step S520, an image (a first image) within a predetermined shooting range is captured in real time as the captured image. Specifically, the image capture device 110 in the electronic device 100 for implementing the face detection method according to an embodiment of the present disclosure as shown in FIG. 1 may be used or other image capture devices independent of the electronic device 100 but capable of transmitting images to the electronic device 100 may be used to capture a grayscale or chromatic image within the predetermined shooting range as the captured image, the captured image may be a photo or one frame in a video.

Steps S530 to S540 correspond to steps S210 to S220 in FIG. 2, respectively, details are no more described herein.

It is determined in step S550 whether the virtual object satisfies a predetermined condition within a predetermined timing period, and the predetermined timing period may be predetermined in advance. Specifically, step S550 may comprise determining whether a timer exceeds a predetermined timing period and whether the virtual object satisfies a predetermined condition. Optionally, a timeout flag may be generated when the timer exceeds the predetermined timing period, and it may be determined in step S550 whether the timer exceeds the predetermined timing period according to the timeout flag.

According to a determination result in step S550, it may be determined that a face of a living body has been detected in step S560, or it is determined that no face of a living body has been detected in step S570, or the processing returns to step S520.

In a case of returning to step S520, an image (a second image) within the predetermined shooting range is captured in real time as the captured image, then steps S530 to S550 are executed. Herein, in order to distinguish the images acquired successively in the predetermined shooting range, an image that is captured first is referred to as a first image, and a subsequently captured image is referred to as a second image. It should be understood that the first image and the second image are images within the same framing coverage, only capturing time is different.

Steps S520 to S550 shown in FIG. 5 are repeatedly executed until it is determined according to the determination result in step S550 that the virtual object satisfies the predetermined condition, so that it is determined in step S570 that a face of a living body has been detected, or until it is determined in step S520 that the timer exceeds the predetermined timing period, so that it is determined in step S580 that no face of a living body has been detected.

Although whether the timer exceeds the predetermined timing period is determined in step S550 in FIG. 5, it should be understood that the present disclosure it not limited thereto, and this determination may be performed in any step of the living body detection method according to an embodiment of the present disclosure. In addition, optionally, a timeout flag is generated when the timer exceeds a predetermined timing period, and the timeout flag may directly trigger step S560 or S570 of the living body detection method according to an embodiment of the present disclosure, that is, determining whether a face of a living body has been detected.

Hereinafter, the living body detection method according to an embodiment of the present disclosure is further described with reference to the specific embodiments.

### First Embodiment

In the first embodiment, the virtual object includes a first group of objects, the first group of objects is displayed on the display screen when starting to execute the living body detection method according to an embodiment of the present disclosure, and the first group of object includes one or more objects. Displaying of at least one object in the first group of objects on the display screen is updated according to the detected facial motion, wherein the at least one object in the first group of objects is a controlled object. An initial display position and/or an initial display form of at least part of the objects in the first group of objects is predetermined or randomly determined.

### First Example

In the first example, the virtual object is a first object, the facial motion attribute includes a first motion attribute, the state parameter of the first object includes a first state parameter of the first object, the value of the first state parameter of the first object is updated according to the value of the first motion attribute, and the first object is displayed on the display screen according to the updated value of the first state parameter of the first object.

Optionally, the facial motion attribute further includes a second motion attribute, the state parameter of the first object further includes a second state parameter of the first object, the value of the second state parameter of the first object is updated according to the value of the second motion attribute, and the first object is displayed on the display screen according to updated values of the first and second state parameters of the first object.

The predetermined condition may be that the first object reaches a target display position and/or a target display form, and the target display form may include a target size, a target color, a target shape, or the like. At least one of the initial display position of the first object on the display screen and the target display position of the first object may be randomly determined, and at least one of the initial display form of the first object on the display screen and the target display form of the first object may be randomly determined. The target display position and/or the target display form may be prompted to the user by, for example, text, voice, or the like.

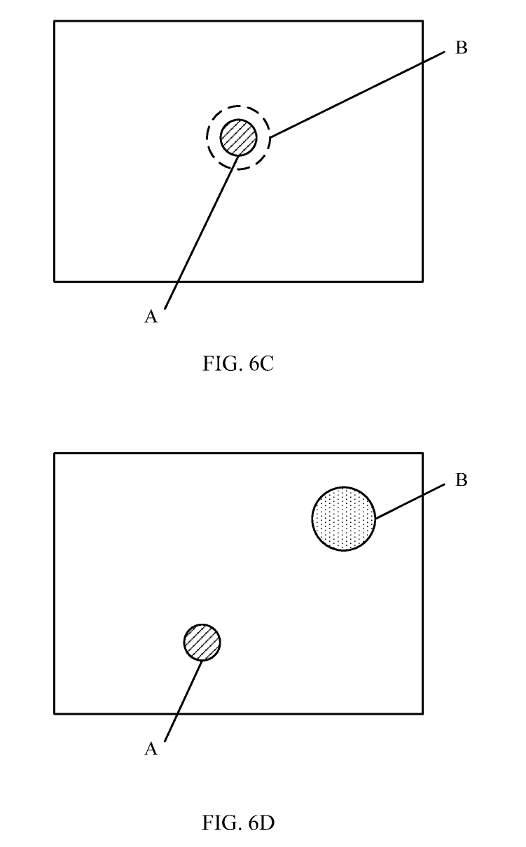

Specifically, the first state parameter of the first object is a display position of the first object, the display position of the first object is controlled according to the value of the first motion attribute. In a case where the display position of the first object coincides with the target display position, it is determined that the living body detection is successful. For example, the initial display position of the first object is randomly determined, the target display position of the first object may be an upper left corner, an upper right corner, a lower left corner, a lower right corner, or a center position on the display screen, or the like. Alternatively, the target display position may be prompted to the user by means of, for example, text, voice, or the like. The first object may be the first object A shown in FIG. 6A.

Specifically, when the timer is initialized, at least a portion of the first object is displayed on the display screen, and an initial display position of at least a portion of the first object is randomly determined. For example, the first object may be a virtual face, and a displayed portion and a display position of the first object may be controlled according to the value of the first motion attribute. In a case where the display position of the first object is the same as the target display position, it is determined that the living body detection is successful. The first object may be the first object A shown in FIG. 6B.

Specifically, the first state parameter of the first object is the size (color or shape) of the first object, and the size (color or shape) of the first object is controlled according to the value of the first motion attribute. In a case where the size (color or shape) of the first object is the same as the target size (target color or target shape), it is determined that the living body detection is successful. The first object may be the first object A shown in FIG. 6C.

### Second Example

In the second example, the virtual object includes a first object and a second object, the facial motion attribute includes a first motion attribute, the state parameter of the first object includes a first state parameter of the first object, the state parameter of the second object includes a first state parameter of the second object, the value of the first state parameter of the first object is updated according to the value of the first motion attribute, the first object is displayed on the display screen according to the updated value of the first state parameter of the first object.

Optionally, the facial motion attribute further includes a second motion attribute, the state parameter of the first object further includes a second state parameter of the first object, the state parameter of the second object includes a second state parameter of the second object, the value of the second state parameter of the first object is updated according to the value of the second motion attribute, and the first object is displayed on the display screen according to updated values of the first and second state parameters of the first object.

In this example, the first object is a controlled object, the second object is a background object and is a target object of the first object.

The predetermined condition may be that the first object coincides with the second object, or the first object reaches a target display position and/or a target display form, and the target display form may include a target size, a target color, a target shape, and so on. Specifically, the display position of the second object is a target display position of the first object, and the display form of the second object is a target display form of the first object.

An initial value of the state parameter of at least one of the first object and the second object may be randomly determined. That is, an initial value of at least one of the state parameters (e.g., at least one of display position, size, color, shape) of the first object may be randomly determined, and/or an initial value of at least one of the state parameters (e.g., at least one of display position, size, color, shape) of the second object may be randomly determined. Specifically, for example, at least one of an initial display position of the first object on the display screen and a display position of the second object may be randomly determined, at least one of an initial display form of the first object on the display screen and a target display form of the second object may be randomly determined.

An example of display positions of the first object A and the target object B of the first object A is shown in FIG. 6A. The first state parameter of the first object A is the display position of the first object A, and the display position of the first object A is controlled according to the value of the first motion attribute. In a case where the display position of the first object A coincides with the target display position (the display position of the second object B), it is determined that the living body detection is successful. In FIG. 6A, other state parameters such as size, color, shape, etc. of the first object A and the target object B are not determined, the determination is made regardless of whether the size, color, shape of the first object A and the target object B are the same.

An example of display positions of the first object A and the target object B of the first object A is shown in FIG. 6B. When a face is detected for the first time in a captured image or when the timer is initialized, the second object B and at least a portion of the first object A are displayed on the display screen, an initial display position of at least a portion of the first object A is randomly determined. For example, the first object A may be a controlled virtual face, the second object B may be a target virtual face, and the displayed portion and the display position of the first object A may be controlled according to the value of the first motion attribute, and in a case where the display position of the first object A is the same as the target display position (the display position of the second object B), it is determined that the living body detection is successful.

An example of sizes of the first object A and the target object B of the first object A is shown in FIG. 6C. The first state parameter of the first object A is the size (color or shape) of the first object A. The size (color or shape) of the first object A is controlled according to the value of the first motion attribute. In a case where the size (color or shape) of the first object A is the same as the target size (target color or target shape) (i.e., the size (color or shape) of the second object B), it is determined that the living body detection is successful.

An example of display positions and display sizes of the first object A and the target object B of the first object A is shown in FIG. 6D. The first state parameter and the second state parameter of the first object A are the display position and the display size of the first object A, respectively, the first state parameter and the second state parameter of the second object B are the display position and the display size of the second object B, respectively.

In the example shown in FIG. 6D, the display position and the display size of the first object A are controlled according to the facial motion. Specifically, the value (display position coordinates) of the first state parameter of the first object A may be updated according to the value of the first motion attribute of the first object A, and the value (size value) of the second state parameter of the first object A may be updated according to the value of the second motion attribute, the first object A is displayed on the display screen according to the value of the first state parameter and the value of the second state parameter of the first object A. In a case where the first object A coincides with the second object B, that is, the display position of the first object A coincides with the display position of the second object B and also the display size of the first object A is the same as the display size of the target object B, the face in the captured image is determined to be a face of a living body.

Optionally, as shown in FIGS. 6A and 6D, both the horizontal position and the vertical position of the first object A and the second object B are different. In this case, the first motion attribute may include a first sub-motion attribute and a second sub-motion attribute, the first state parameter of the first object A may include a first sub-state parameter and a second sub-state parameter, the value of the first sub-state parameter is a horizontal position coordinate of the first object A, the value of the second sub-state parameter is a vertical position coordinate of the first object A, the horizontal position coordinate of the first object A on the display screen may be updated according to the value of the first sub-motion attribute, and the vertical position coordinate of the first object A on the display screen may be updated according to the value of the second sub-motion attribute.

For example, the first motion attribute may be defined as the position of the face in the captured image, and the display position of the first object A on the display screen is updated according to the position coordinates of the face in the captured image. In this case, the first sub-motion attribute may be defined as a horizontal position of the face in the captured image and the second sub-motion attribute may be defined as a vertical position of the face in the captured image, the horizontal position coordinate of the first object A on the display screen may be updated according to the horizontal position of the face in the captured image, and the vertical position coordinate of the first object A on the display screen may be updated according to the vertical position of the face in the captured image.

Another example, the first sub-motion attribute may be defined as a degree of face deflection and the second sub-motion attribute may be defined as a degree of face tilting, then the horizontal position coordinate of the first object A on the display screen may be updated according to the value of the degree of face deflection, and the vertical position coordinate of the first object A on the display screen may be updated according to the value of the degree of face tilting.

### Third Example

In the third example, the virtual object includes a first object and a second object, the first object is a controlled object, the second object is a background object and is a target motion trajectory of the first object. The facial motion attribute includes a first motion attribute, a state parameter of the first object includes a first state parameter of the first object, and the first state parameter of the first object is a display position of the first object, the value of the first state parameter of the first object is updated according to the value of the first motion attribute, and a display position of the first object on the display screen is controlled according to the updated value of the first state parameter of the first object, and the motion trajectory of the first object is controlled accordingly.

Optionally, the virtual object may further include a third object. In this case, the second object and the third object together constitute a background object, the second object is a target motion trajectory of the first object, the third object is a target object of the first object, and the background object includes the target motion trajectory and the target object of the first object. The state parameter of the third object includes a first state parameter of the third object, and the first state parameter of the third object is a display position of the third object.

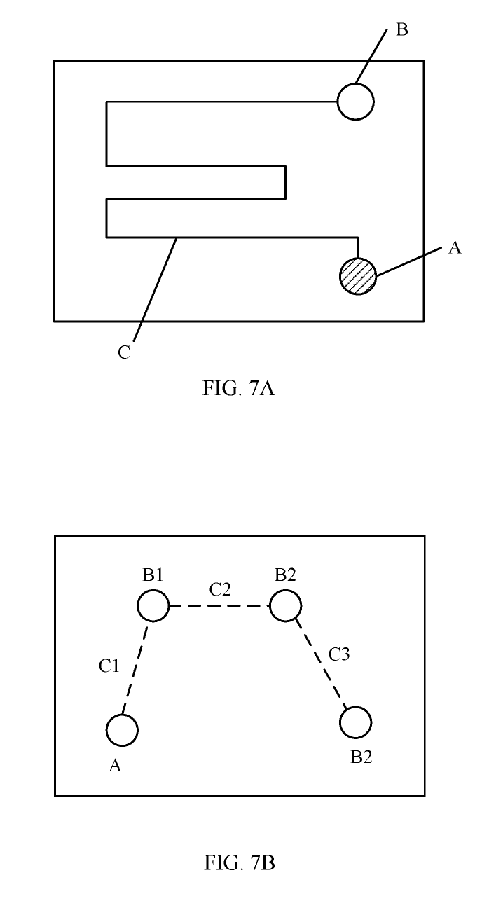

The first object A, the second object (target object) B, and the third object C (target motion trajectory) are shown in FIGS. 7A and 7B. An initial display position of the first object A, a display position of the target object B, and at least a portion of the target motion trajectory C may be randomly determined.

As shown in FIG. 7A, in a case where the motion trajectory of the first object A coincides with the target motion trajectory C, it is determined that the living body detection is successful. In addition, in a case where the target object B is displayed on the display screen, the state parameter of the target object B may include a first state parameter of the target object B, and the first state parameter of the target object B is the display position of the target object B. In this case, optionally, it may be also determined that the living body detection is successful if the motion trajectory of the first object A coincides with the target motion trajectory C and also the display position of the first object A coincides with the display position of the target object B.

As shown in FIG. 7B, in a case where a plurality of target objects B (B1, B2, B3) and a plurality of segments of target motion trajectories C (C1, C2, C3) are displayed on the display screen, the state parameter of each target object may include the first state parameter of the target object, i.e., the display position. It may be determined that the living body detection is successful in a case where the motion trajectory of the first object A sequentially coincides with at least part of the plurality of segments of the target motion trajectories C. Alternatively, it may be determined that the living body detection is successful in a case where the first object A sequentially coincides with at least part of the plurality of target objects. Alternatively, it may be determined that the living body detection is successful in a case where the motion trajectory of the first object A sequentially coincides with at least part of the plurality of segments of the target motion trajectories C and also the first object A sequentially coincides with at least part of the plurality of target objects B.

As shown in FIG. 7A and FIG. 7B, a motion direction of the first object A may include a horizontal motion direction and a vertical motion direction when moving along the target motion trajectory C. Specifically, the first motion attribute may include a first sub-motion attribute and a second sub-motion attribute, the first state parameter of the first object A may include a first sub-state parameter and a second sub-state parameter, the value of the first sub-state parameter is a horizontal position coordinate of the first object A, the value of the second sub-state parameter is a vertical position coordinate of the first object A, the horizontal position coordinate of the first object A on the display screen may be updated according to the value of the first sub-motion attribute, and the vertical position coordinate of the first object A on the display screen may be updated according to the value of the second sub-motion attribute.

Optionally, the facial motion attribute further includes a second motion attribute, and the state parameter of the first object further includes a second state parameter of the first object, and the second state parameter of the first object is a display form (e.g., size, color, shape, etc.) of the first object, the state parameter of the third object includes a second state parameter of the third object, and the second state parameter of the third object is a display form (e.g., size, color, shape, etc.) of the third object, the value of the second state parameter of the first object is updated according to the value of the second motion attribute, and the first object is displayed on the display screen according to updated values of the first and second state parameters of the first object.

Although the target object B is shown as an object having a specific shape in FIGS. 6A, 6C, 6D, 7A, and 7B, it should be understood that the present disclosure is not limited thereto and the target object B may also be represented by “+”.

In the first embodiment, in a case of applying the living body detection method shown in FIG. 5, it is determined in step S550 whether the timer exceeds the predetermined timing period and whether the first object satisfies the predetermined condition, such as whether the first object reaches the target display position and/or the target display form, whether the first object coincides with the target object and/or has the same display form of the target object, and/or whether the first object achieves the target motion trajectory.

In a case where it is determined in step S550 that the timer exceeds the predetermined timing period and the first object does not satisfy the predetermined condition, it is determined in step S570 that no face of a living body has been detected.

In a case where it is determined in step S550 that the timer does not exceed the predetermined timing period and the first object satisfies the predetermined condition, it is determined in step S560 that a face of a living body has been detected.

On the other hand, in a case where it is determined in step S550 that the timer does not exceed the predetermined timing period and the first object does not satisfy the predetermined condition, the processing returns to step S520.

### Second Embodiment

In the second embodiment, the virtual object includes a first group of objects, the first group of objects is displayed on the display screen when starting to execute the living body detection method according to an embodiment of the present disclosure, and the first group of object includes one or more objects. Displaying of at least one object in the first group of objects on the display screen is updated according to the detected facial motion, wherein the at least one object in the first group of objects is a controlled object. An initial display position and/or an initial display form of at least part of the objects in the first group of objects is predetermined or randomly determined.

In the following example, the first group of objects includes a first object and a second object, the first object is a controlled object, the second object is a background object, the background object is an obstacle object, and initial display positions and/or initial display forms of the first object and the obstacle object are random. The obstacle object may be stationary or may be moving. In a case where the obstacle object is moving, a motion trajectory of the obstacle object may be a straight line or a curve, and the obstacle object may move in a vertical direction, a horizontal direction, or an arbitrary direction. Optionally, the motion trajectory and the motion direction of the obstacle object are also random.

The facial motion attribute includes a first motion attribute, a state parameter of the first object includes a first state parameter of the first object, the first state parameter of the first object is a display position of the first object, a state parameter of the second object includes a first state parameter of the second object, the first state parameter of the second object is a display position of the second object, the value of the first state parameter of the first object is updated according to the value of the first motion attribute, and the first object is displayed on the display screen according to the updated value of the first state parameter of the first object.

The predetermined condition may be that the first object and the second object do not meet or a distance between the display position of the first object and the display position of the second object exceeds a predetermined distance, the predetermined distance may be determined according to the display size of the first object and the display size of the second object. Optionally, the predetermined condition may be that the first object and the second object do not meet within a predetermined time period, or a distance between the display position of the first object and the display position of the second object exceeds a predetermined distance.

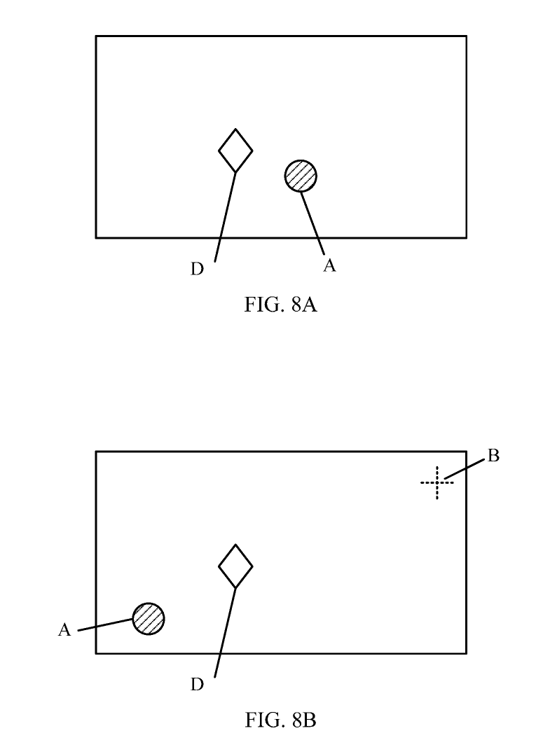

An example of positions of the first object A and the obstacle object D is shown in FIG. 8A. The obstacle object D may continuously move on the display screen, and the motion direction of the obstacle object D may be random. In a case where the first object A and the obstacle object D do not meet, it is determined that the living body detection is successful. Preferably, in a case where the first object A and the obstacle object D never meet within a predetermined timing period, it is determined that the living body detection is successful. Alternatively, in a case where the first object A and the obstacle D never meet before the obstacle D moves out of the display screen, it is determined that the live detection is successful.

Optionally, the first group of objects further includes a third object, the first object is a controlled object, the second object and the third object together constitute a background object, the second object is an obstacle object, the third object is a target object, the obstacle object is randomly displayed or randomly generated. The state parameter of the third object may include a first state parameter of the third object, and the first state parameter of the third object may be a display position of the third object.

The predetermined condition may be that the first object and the second object do not meet and the first object coincides with the third object; or a distance between the display position of the first object and the display position of the second object exceeds a predetermined distance and the first object coincides with the third object, the predetermined distance may be determined according to the display size of the first object and the display size of the second object.

The first object A, the second object (obstacle object) D, and the third object (target object) B are shown in FIG. 8B. The obstacle object D may continuously move on the display screen, and a motion direction of the obstacle object D may be random. In a case where the first object A and the obstacle object D do not meet and the first object A coincides with the target objects B, it is determined that the living body detection is successful. Preferably, in a case where the first object A and the obstacle object D do not meet within a predetermined timing period and the display position of the first object A coincides with the display position of the target object B, it is determined that the living body detection is successful.

In the second embodiment, in a case of applying the living body detection method shown in FIG. 5, it is determined in step S550 whether the timer exceeds the predetermined timing period, and whether the first object satisfies a predetermined condition, the predetermined condition is, for example, that the first object and the obstacle object do not meet (FIG. 8A), the first object coincides with the target object (FIG. 8B-1), and the first object coincides with the target object but does not meet the obstacle target (FIG. 8B-2).

As for the example shown in FIG. 8A, it is determined in step S560 that a face of a living body has been detected in a case where it is determined in step S550 that the timer exceeds a predetermined timing period and the first subject never meets the obstacle target; the processing returns to step S520 in a case where it is determined in step S550 that the timer does not exceed a predetermined timing period and the first subject never meets the obstacle target; on the other hand, it is determined in step S570 that no face of a living body has been detected in a case where it is determined in step S550 that the timer does not exceed a predetermined time period and the first object meets the obstacle object.

As for the example shown in FIG. 8B-1, it is determined in step S570 that no face of a living body has been detected in a case where it is determined in step S550 that the timer exceeds a predetermined timing period and the first object does not coincide with the target object; it is determined in step S560 that a face of a living body has been detected in a case where it is determined in step S550 that the timer does not exceed a predetermined timing and the first object coincides with the target object; on the other hand, the process returns to step S520 in a case where it is determined in step S550 that the timer does not exceed the predetermined timing period and the first object does not coincide with the target object.

As for the example shown in FIG. 8B-2, it is determined in step S570 that no face of a living body has been detected in a case where it is determined in step S550 that the timer exceeds a predetermined timing period and the first object does not coincide with the target object, or it is determined in step S550 that the timer does not exceed a predetermined timing period and the first object meets the obstacle object; it is determined in step S560 that a face of a living body has been detected in a case where it is determined in step S550 that the timer does not exceed a predetermined timing period and the first object coincides with the target object and never meets the obstacle object; and on the other hand, the processing returns to step S520 in a case where it is determined in step S550 that the timer does not exceed a predetermined timing period and the first object does not coincide with the target object and does not meet the obstacle object.

In the examples shown in FIGS. 8A and 8B, the first motion attribute may include a first sub-motion attribute and a second sub-motion attribute, and the first state parameter of the first object A may include a first sub-state parameter and a second sub-state parameter, the value of the first sub-state parameter is a horizontal position coordinate of the first object A and the value of the second sub-state parameter is a vertical position coordinate of the first object A, the horizontal position coordinate of the first object A on the display screen may be updated according to the value of the first sub-motion attribute, and the vertical position coordinate of the first object A on the display screen may be updated according to the value of the second sub-motion attribute.

### Third Embodiment

In the third embodiment, the virtual object includes a first group of objects and a second group of objects, the first group of objects is displayed on the display screen when starting to execute the living body detection method according to an embodiment of the present disclosure, and the first group of objects includes one or more objects, the second group of objects has not been displayed on the display screen when starting to execute the living body detection method according to an embodiment of the present disclosure, and the second group of objects includes one or more objects. Displaying of at least one object in the first group of objects on the display screen is updated according to the detected facial motion, wherein the at least one object in the first group of objects is a controlled object. Optionally, an initial display position and/or an initial display form of at least part of the objects in the first group of objects is predetermined or randomly determined.

Optionally, at least one object in the second group of objects is displayed according to display situation of at least one object in the first group of objects. Alternatively, at least one object in the second group of objects may be displayed based on the detected facial motion. Optionally, an initial display position and/or an initial display form of at least part of the objects in the second group of objects is predetermined or randomly determined.

In this embodiment, the first state parameter of each object in the first group of objects is the display position of the object, and the first and second state parameters of each object in the second group of objects are the display position and the visible state of said object, respectively.

### First Example

In the first example, at least one object in the second group of objects is displayed according to display situation of at least one object in the first group of objects.

Specifically, the first group of objects includes a first object and a second object, the first object is a controlled object, the second object is a background object, and each object in the second group of objects is also a background object. The predetermined condition may be that the controlled object in the first group of objects coincides with the second object and each object in the second group of objects in sequence.

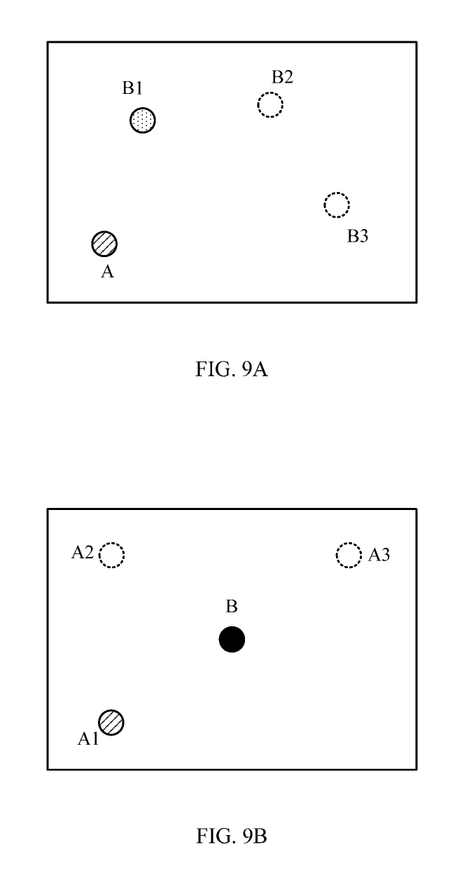

As shown in FIG. 9A, the first group of objects includes a first object A and a second object B1, the second group of objects includes a third object B2 and a fourth object B3, the first object A is a controlled object, the second object B1, the third object B2, and the fourth object B3 all are background objects, and the background objects are target objects.

The facial motion attribute includes a first motion attribute, a state parameter of the first object A includes a first state parameter of the first object A, a state parameter of the second object B1 includes a first state parameter of the second object B1, a state parameter of the third object B2 includes a first state parameter of the third object B2, and a state parameter of the fourth object B3 includes a first state parameter of the fourth object B3.

First, the value of the first state parameter of the first object A is updated according to the value of the first motion attribute, and the first object A is displayed on the display screen according to the updated value of the first state parameter of the first object A.

After the display positions of the first object A and the second object B1 coincide, the value of the second state parameter of the third object B2 in the second group of objects is set to a value that indicates being visible, for displaying the third object B2 in the second group of objects. Optionally, the value of the first state parameter of the first object A may continue to be updated on the display screen according to the value of the first motion attribute, and the first object A may be displayed according to the updated value of the first state parameter of the first object A. Alternatively, the facial motion attribute may further include a second motion attribute that is different from the first motion attribute, the value of the first state parameter of the first object A may be continue to be updated according to the value of the second motion attribute, and the first object A may be displayed on the display screen according to the updated value of the first state parameter of the first object A.

After the display positions of the first object A and the third object B2 coincide, the value of the second state parameter of the fourth object B3 in the second group of objects is set to be a value that indicates being visible, for displaying the fourth object B3 in the second group of objects. Optionally, the value of the first state parameter of the first object A may continue to be updated according to the value of the first or second motion attribute, and the first object A may be displayed on the display screen according to the updated value of the first state parameter of the first object A. Alternatively, the facial motion attribute may further include a third motion attribute that is different from the first and second motion attributes, the value of the first state parameter of the first object A may continue to be updated according to the value of the third motion attribute, and the first object A may be displayed according to the updated value of the first state parameter of the first object A.

In a case where the first object A sequentially coincides with the second object B1, the third object B2, and the fourth object B3, it is determined that the living body detection is successful. Optionally, in a case where the first object A sequentially coincides with the second object B1, the third object B2, and the fourth object B3 within a predetermined time period, it is determined that the living body detection is successful.

In a case of applying the living body detection method shown in FIG. 5, it is determined in step S550 whether the timer exceeds the predetermined timing period, and whether the first object A sequentially coincides with the second object B1, the third object B2, and the fourth object B3.

In a case where it is determined in step S550 that the timer exceeds the predetermined timing period and the first object A coincides with none of the second object B1, the third object B2, and the fourth object B3, or coincides with none of the third object B2 and the fourth B3, or does not coincide with the fourth object B3, it is determined in step S570 that no face of a living body has been detected.

In a case where it is determined in step S550 that the timer does not exceed the predetermined timing period and the first object A sequentially coincides with the second object B1, the third object B2, and the fourth object B3, it is determined in step S560 that a face of a living body has been detected.

On the other hand, in a case where it is determined in step S550 that the timer does not exceed the predetermined timing and the first object A coincides with none of the second object B1, the third object B2, and the fourth object B3, or coincides with none of the third object B2 and the fourth object B3, or does not coincide with the fourth object B3, the processing returns to step S520.

More specifically, in a case of returning from step S550 to step S520, it is also possible to execute the following steps: determining whether the fourth object has been displayed; if it is determined that that the fourth object has not been displayed, determining whether the third object has been displayed; if it is determined that the third object has not been displayed, determining whether the first object coincides with the second object; if it is determined that the first object coincides with the second object, displaying the third object thereafter returning to step S520; if it is determined that the fourth object has not been displayed but the third object has been displayed, determining whether the first object coincides with the third object; and if it is determined that the first object coincides with the third object, displaying the fourth object, thereafter returning to step S520.

Alternatively, the number of objects included in the second group of objects may be set, and in a case where the first object A sequentially coincides with the second object B1 and each object in the second group of objects, it is determined that the living body detection is successful.

### Second Example

In the second example, at least one object in the second group of objects is displayed according to display situation of at least one object in the first group of objects, and at least part of the objects in the second group of objects is a controlled object.

Specifically, the first group of objects includes a first object and a second object, the first object is a controlled object, the second object is a background object, and each object in the second group of objects is also a controlled object. The predetermined condition may be that the first object and each object in the second group of objects sequentially coincide with the second object.

As shown in FIG. 9B, the first group of objects includes a first object A1 and a second object B, and the second group of objects includes a third object A2 and a fourth object A3. The first object A1, the three objects A2, and the fourth object A3 are controlled objects, and the second object B is a background object.

The facial motion attribute includes a first motion attribute, a state parameter of the first object A1 includes a first state parameter of the first object A1, a state parameter of the second object B includes a first state parameter of the second object B, a state parameter of the third object A2 includes a first state parameter of the third object A2, and a state parameter of the fourth object A3 includes a first state parameter of the fourth object A3.

First, the value of the first state parameter of the first object A1 is updated according to the value of the first motion attribute, and the first object A1 is displayed on the display screen according to the updated value of the first state parameter of the first object A1.

After the display positions of the first object A1 and the second object B coincide, the value of the second state parameter of the third object A2 in the second group of objects is set to be a value that indicates being invisible, for displaying the third object A2 in the second group of objects. Optionally, the value of the first state parameter of the third object A2 may continue to be updated according to the value of the first motion attribute, and the third object A2 may be displayed on the display screen according to the updated value of the first state parameter of the third object A2, while the display position of the first object A1 remains unchanged. Alternatively, the facial motion attribute may further include a second motion attribute different from the first motion attribute, and it may continue to update the value of the first state parameter of the third object A2 according to the value of the second motion attribute, and the third object A2 is displayed on the display screen according to the updated value of the first state parameter of the third object A2.

After the display position of the third object A2 and the second object B coincide, the value of the second state parameter of the fourth object A3 in the second group of objects is set to be a value that indicates being visible, for displaying the fourth object A3 in the second group of objects. Optionally, the value of the first state parameter of the fourth object A3 may continue to be updated according to the value of the first or second motion attribute, and the fourth object A3 may be displayed on the display screen according to the updated value of the first state parameter of the fourth object A3, while the display positions of the first and second objects A1 and A2 remain unchanged. Alternatively, the facial motion attribute may further include a third motion attribute that is different from the first and second motion attributes, and the value of the first state parameter of the fourth object A3 may continue to be updated according to the value of the third motion attribute, and the fourth object A3 is displayed on the display screen according to the updated value of the first state parameter of the fourth object A3.

In a case where the first object A1, the third object A2, and the fourth object A3 sequentially coincide with the second object B, it is determined that the living body detection is successful. Optionally, in a case where the first object A1, the third object A2, and the fourth object A3 sequentially coincide with the second object B within a predetermined time period, it is determined that the living body detection is successful.

In a case of applying the living body detection method shown in FIG. 5, it is determined in step S550 whether the timer exceeds the predetermined timing period, and whether the first object A1, the third object A2, and the fourth the object A3 sequentially coincides with the second object B.

In a case where it is determined in step S550 that the timer exceeds the predetermined timing period and the first object A1 does not coincide with the second object B or the third object A2 does not coincide with the second object B or the fourth object A3 does not coincide with the second object B, it is determined in step S570 that no face of a living body has been detected.

In a case where it is determined in step S550 that the timer does not exceed the predetermined timing and the first object A1, the third object A2, and the fourth object A3 sequentially coincide with the second object B, it is determined in step S560 that a face of a living body has been detected.

On the other hand, it is determined in step S550 that the timer does not exceed the predetermined timing period and the first object A1 does not coincide with the second object B, or the third object A2 does not coincide with the second object B, or the fourth object A3 does not coincide with the second object B, the processing returns to step S520.

More specifically, in a case of returning from step S550 to step S520, it is also possible to execute the following steps: determining whether the fourth object has been displayed; if it is determined that the fourth object has not been displayed, determining whether the third object has been displayed; if it is determined that the third object has not been displayed, determining whether the first object coincides with the second object; if it is determined that the first object coincides with the second object, displaying the third object, thereafter returning to step S520; if it is determined that the fourth object has not been displayed but the third object has been displayed, determining whether the third object coincides with the second object; and if it is determined that the third object coincides with the second object, displaying the fourth object, thereafter the processing returns to step S520.

Optionally, the number of objects included in the second group of objects may be set, and in a case where the first object A1 and each object in the second group of objects sequentially coincide with the second object B, it is determined that the living body detection is successful.

### Third Example

In the third example, at least one object in the second group of objects is displayed according to display situation of at least one object in the first group of objects, and at least part of the objects in the second group of objects is a controlled object.

Specifically, as shown in FIG. 9C, the first group of objects includes a first object A1 and a second object B1, the first object A1 is a controlled object, the second object B1 is a background object, and the second groups of objects include a third object A2 and a fourth object B2, as well as a fifth object A3 and a sixth object B3. The third object A2 and the fifth object A3 are both controlled objects, and the fourth object B2 and sixth object B3 are both background objects. The predetermined condition may be that the second object B1 and the first object A1 coincide, the fourth object B2 and the third object A1 coincide, the sixth object B3 and the fifth object A3 coincide.

The facial motion attribute includes a first motion attribute. The value of the first state parameter of the first object A1 is updated according to the value of the first motion attribute, and the first object A1 is displayed updated on the display screen according to the updated value of the first state parameter of the first object A1.

After the display positions of the first object A1 and the second object B1 coincide, the third object A2 and the fourth object B2 in the second group of objects are displayed. Optionally, the value of the first state parameter of the third object A2 may continue to be updated according to the value of the first motion attribute, and the third object A2 is displayed on the display screen according to the updated value of the first state parameter of the third object A2. Alternatively, the facial motion attribute may further include a second motion attribute different from the first motion attribute, the value of the first state parameter of the third object A2 may continue to be updated according to the value of the second motion attribute, and the third object A2 is displayed on the display screen according to the updated value of the first state parameter of the third object A2.

After the display positions of the third object A2 and the fourth object B2 coincide, the fifth object A3 in the second group of objects is displayed. Optionally, the value of the first state parameter of the fifth object A3 may continue to be updated according to the value of the first or second motion attribute, and the fifth object A3 is displayed on the display screen according to the updated value of the first state parameter of the fifth object A3. Alternatively, the facial motion attribute may further include a third motion attribute that is different from the first and second motion attributes, the value of the first state parameter of the fifth object A3 may continue to be updated according to the value of the third motion attribute, the fifth object A3 is displayed on the display screen according to the updated value of the first state parameter of the fifth object A3.

In a case where the first object A1, the third object A2, and the fifth object A3 sequentially coincide with the second object B1, the fourth object B2, and the sixth object B3, it is determined that the living body detection is successful. Optionally, in a case where the first object A1, the third object A2, and the fifth object A3 sequentially coincide with the second object B1, the fourth object B2, and the sixth object B3 within a predetermined time period, it is determined that the living body detection is successful.

In a case of applying the living body detection method shown in FIG. 5, it is determined in step S550 whether the timer exceeds the predetermined timing period, and whether the first object A1, the third object A2, and the fifth object A3 sequentially coincide with the second object B1, the fourth object B2, and the sixth object B3.

In a case where it is determined in step S550 that the timer exceeds the predetermined timing period and the fifth object A3 does not coincide with the sixth object B3 or the third object A2 does not coincide with the fourth object B2 or the first object A1 does not coincide with the second object B1, it is determined in step S570 that no face of a living body has been detected.

In a case where it is determined in step S550 that the timer does not exceed the predetermined timing period and the first object A1, the third object A2, and the fifth object A3 sequentially coincide with the second object B1, the fourth object B2, and sixth subject B3, it is determined in step S560 that a face of a living body has been detected.

On the other hand, in a case where it is determined in step S550 that the timer does not exceed the predetermined timing period and the fifth object A3 does not coincide with the sixth object B3 or the third object A2 does not coincide with the fourth object B2 or the first object A1 does not coincide the second object B1, the processing returns to step S520.

More specifically, in a case of returning from step S550 to step S520, the following steps may be further executed: determining whether the fifth and sixth objects have been displayed; if it is determined that the fifth and sixth objects have not been displayed, determining whether the third and fourth objects has been displayed; if it is determined that the third and fourth objects have not been displayed, determining whether the first object coincides with the second object; if it is determined that the first object coincides with the second object, displaying the third and fourth objects, thereafter the processing returns to step S520; if it is determined that the fifth and sixth objects have not been displayed but the third and fourth objects have been displayed, determining whether the third object coincides with the fourth object; if it is determined that the third object coincides with the fourth object, displaying the fifth and sixth objects, thereafter the processing returns to step S520.

Alternatively, the number of object pairs included in the second group of objects may be set, wherein the object A2 and the object B2 may be regarded as one object pair, in a case where each object Ai sequentially coincides with its corresponding object Bi it is determined that the living body detection is successful. Optionally, in a case where each object Ai sequentially coincides with its corresponding object Bi in a predetermined time period, it is determined that the living body detection is successful.

### Fourth Example

In the fourth example, at least one object in the second group of objects is displayed based on the detected facial motion.

Specifically, as shown in FIG. 9D, the first group of objects includes a first object A1 and a second object B, the first object A is a controlled object, and the second object B is a background object; the second group of objects includes a third object A2, and the second object B is a target object B of the first object A1 and the third object A2. The predetermined condition may be that the third object A2 coincides with the second object B, or the first and third objects A1 and A2 sequentially coincide with the second object.

The value of the state parameter of at least one of the first object A1 and the target object B may be randomly determined. For example, the display position of the first object A1 is randomly determined, and/or the display position of the target object B is randomly determined.

The facial motion attribute includes a first motion attribute and a second motion attribute, and coordinates of the display position of the first object are updated according to the value of the first motion attribute, and a visible state value of the second object is updated according to the value of the second motion attribute, for example, the visible state value 0 indicates that the second object is invisible, that is, the second object is not displayed; and the visible state value 1 indicates that the second object is visible. Optionally, the predetermined condition may be that the display position of the third object A2 and the display position of the second object B coincide. Alternatively, the predetermined condition may be that the display positions of the first object A1 and the third object A2 coincide with the display position of the target object B.

Specifically, the first object A1 is initially displayed but the third object A2 is not initially displayed, the display position of the first object A1 is changed according to the first motion attribute, the visible state of the second object according to the second motion attribute, and the display position of the third object A2 is determined according to the display position of the first object A1 as the value of the second motion attribute changes. For example, the display position of the third object A2 is the same as the display position of the first object A1 when the value of the second motion attribute changes, in a case where the display position of the third object A2 coincides with the display position of the target object B, it is determined that the living body detection is successful.

As for the example shown in FIG. 9D, in the living body detection, the living body detection is determined as successful only in the following scenario: the display position of the first target A1 is changed according to the first motion attribute, the first target A1 is moved to the target object B, then a change of the second motion attribute is detected when the first object A1 is located at the target object B, the third object A2 is displayed at the target object B accordingly. Specifically, for example, the first object A1 is a sight, the second object B is a bullseye, and the third object A2 is a bullet.

In a case of applying the living body detection method shown in FIG. 5, it is determined in step S550 whether the timer exceeds the predetermined timing period and whether the third object A2 coincides with the second object B.

In a case where it is determined in step S550 that the timer exceeds the predetermined timing period and the third object A2 has not been displayed or the third object A2 has been displayed but does not coincide with the second object B, it is determined in step S570 that no face of a living body has been detected.

In a case where it is determined in step S550 that the timer does not exceed the predetermined timing period and the third object A2 coincides with the second object B, it is determined in step S560 that a face of a living body has been detected.

On the other hand, in a case where it is determined in step S550 that the timer does not exceed the predetermined timing period and the third object A2 has not been displayed, the processing returns to step S520.

### Fifth Example

In the fifth example, at least one object in the second group of objects is displayed according to the detected facial motion, and at least part of the objects in the second group of objects is a controlled object.

As shown in FIG. 9E, the first group of objects includes a first object A1 and a second object B1, the first object A1 is a controlled object, and the second object B1 is a background object; the second group of objects including a third object A2 and a fourth object B2, the third object A2 is a controlled object, and the fourth object B2 is a background object. The predetermined condition may be that the first object A1 coincides with the second object B1 and the third object A2 coincides with the fourth object B2.

The value of the state parameter of at least one of the first object A1, the second object B1, the third object A2, and the fourth object B2 may be randomly determined. For example, the display positions of the first object A1, the second object B1, the third object A2, and the fourth object B2 are randomly determined.

The facial motion attribute includes a first motion attribute and a second motion attribute. Coordinates of the display position of the first object A1 are updated according to the value of the first motion attribute, and the visible state values of the third and fourth objects are updated according to the value of the second motion attribute, for example, the visible state value 0 indicates being invisible, i.e., the third and fourth objects are not displayed; the visible state value 1 indicates being visible, i.e., the third and fourth objects are displayed.

In addition, coordinates of the display position of the third object may be also updated according to the value of the first motion attribute. Optionally, the facial motion attribute further includes a third motion attribute different from the first motion attribute, and coordinates of the display position of the third object are updated according to the value of the third motion attribute.

Specifically, the first object A1 and the second object B1 are initially displayed but the third object A2 and the fourth object B2 are not initially displayed, and the display position of the first object A1 is changed according to the first motion attribute, and the visible state of the second object is changed according to the second motion attribute changing. The initial display position of the third object A2 may be determined according to the display position of the first object A1 when the value of the second motion attribute value changes or the initial display position of the third object A2 may be randomly determined. In this example, the living body detection is determined as successful only in the following scenario: the display position of the first object A1 is changed according to the first motion attribute, the first object A1 is moved to the second object B1, then a change of the second motion attribute is detected when the first object A1 is located at the second object B1, thereby the third object A2 is displayed at a random position or at a display position determined according to the display position of the second object B1, and the fourth object B2 is randomly displayed, then the display position of the third object A2 is changed according to the first motion attribute or the third motion attribute different from the first motion attribute until the third object A2 is moved to the fourth object B2.

As mentioned above, the first motion attribute may include a first sub-motion attribute and a second sub-motion attribute, the first state parameter of the first object A1 may include a first sub-state parameter and a second sub-state parameter, the value of the first sub-state parameter and the value of the second sub-state parameter of the first object A1 are the horizontal position coordinate and the vertical position coordinate of the first object A, respectively, and the horizontal position coordinate and the vertical position coordinate of the first object A on the display screen may be updated according to the value of the first sub-motion attribute and the value of the second sub-motion attribute, respectively.

In addition, the third motion attribute may also include a third sub-motion attribute and a fourth sub-motion attribute, the first state parameter of the second object A2 may include a first sub-state parameter and a second sub-state parameter, and the value of the first sub-state parameter and the value of the second sub-state parameter of the second object A2 are the horizontal position coordinate and the vertical position coordinate of the second object A2, respectively, the horizontal position coordinate and the vertical position coordinate of the second object A2 on the display screen can be updated according to the value of the third sub-motion attribute and the value of the fourth sub-motion attribute, respectively.

For example, the first sub-motion attribute and the second sub-motion attribute may be defined as the degree of face deflection and the degree of face tilting, respectively, or the third sub-motion attribute and the fourth sub-motion attribute may be defined as the degree of leftward and rightward eyeball rotation and the degree of upward and downward eyeball rotation, respectively.

### Fourth Embodiment

In the fourth embodiment, the virtual object includes a first group of objects and a second group of objects, the first group of objects is displayed on the display screen when starting to execute the living body detection method according to an embodiment of the present disclosure, and the first group of objects includes one or more objects; the second group of objects has not been displayed on the display screen when starting to execute the living body detection method according to an embodiment of the present disclosure, and the second group of objects includes one or more objects. Displaying of at least one object in the first group of objects on the display screen is updated according to the detected facial motion, wherein the at least one object in the first group of objects is a controlled object. An initial display position and/or an initial display form of at least part of the objects in the first group of objects is predetermined or randomly determined.

Optionally, at least one object in the second group of objects is displayed according to display situation of at least one object in the first group of objects. Alternatively, at least one object in the second group of objects may be displayed based on the detected facial motion. Optionally, an initial display position and/or an initial display form of at least part of the objects in the second group of objects is predetermined or randomly determined.

In this embodiment, the first state parameter of each object in the first group of objects is the display position of the object, and the first and second state parameters of each object in the second group of objects are the display position and the visible state of the object, respectively.

In this embodiment, the first group of objects includes a first object and a second object, the second group of objects includes a plurality of objects, the first object is a controlled object, the second object and the second group of objects are background objects, the background objects are obstacle objects, and initial display positions and/or initial display forms of the first object and the obstacle objects are random. In a case where an obstacle object is moving, a motion trajectory of the obstacle object may be a straight line or a curve, and the obstacle object may move in a vertical direction, a horizontal direction, or an arbitrary direction. Optionally, the motion trajectory and the motion direction of the obstacle object are also random.

The facial motion attribute includes a first motion attribute, a state parameter of the first object includes a first state parameter of the first object, the first state parameter of the first object is a display position of the first object, the value of the first state parameter of the first object is updated according to the value of the first motion attribute, and the first object is displayed on the display screen according to the updated value of the first state parameter of the first object.

The predetermined condition may be that the first object meets none of the obstacle objects, or a distance between the display position of the first object and the display position of the second object exceeds a predetermined distance, the predetermined distance may be determined according to the display size of the first object and the display size of the second object. Optionally, the predetermined condition may be that the first object and the obstacle objects do not meet within a predetermined time period, or the first object does not meet a predetermined number of obstacle objects, or the first object does not meet a predetermined number of obstacle objects within a predetermined time period.

### First Example

In the first example, at least one object in the second group of objects is displayed according to display situation of at least one object in the first group of objects. Objects in the second group of objects are non-controlled objects, that is, background objects, and the background objects are obstacle objects.

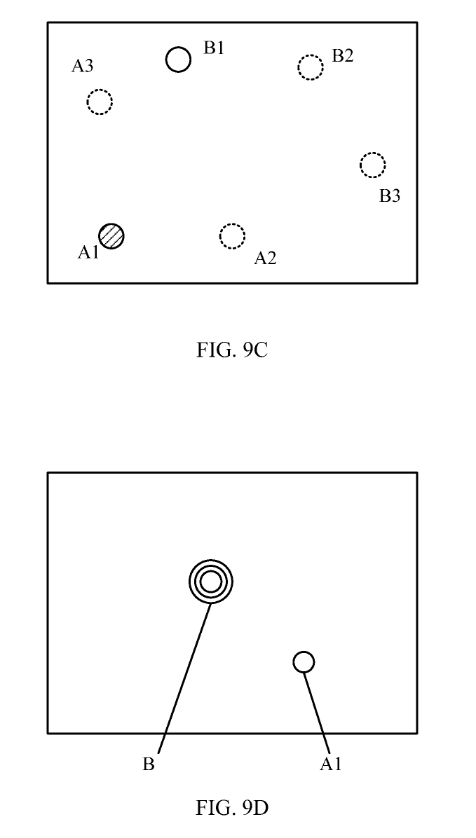

An example of positions of the first object A and the obstacle object D is shown in FIG. 10A. The obstacle object D may continuously move on the display screen, and a motion direction of the obstacle object D may be random.

The obstacle D2 in the second group of objects is displayed when the obstacle D moves out of the display screen, and the obstacle object D3 in the second group of objects is displayed when the obstacle D2 moves out of the display screen, and so on, and so forth, until a predetermined timing period arrives, or a predetermined number of obstacle objects have been displayed.

Optionally, in a case where the first object A never meets the obstacle target within a predetermined time period, it is determined that the living body detection is successful. Alternatively, in a case where the first object A does not meet a predetermined number of obstacle objects, it is determined that the living body detection is successful. Alternatively, in a case where the first object A does not meet a predetermined number of obstacle objects within a predetermined timing period, it is determined that the living body detection is successful.

Optionally, the first group of objects further includes a third object, the second object and the third object constitute a background object, and the third object is a target object. The predetermined condition may be that the first object never meets the obstacle object within a predetermined timing period and the first object coincides with the third object.

The first object A, the second object (obstacle object) D, and the third object (target object) B in the first group of objects and the obstacle objects D1 and D2 in the second group of objects are shown in FIG. 10B. The obstacle objects may continuously move on the display screen, and a motion direction of the obstacle object D may be random. In a case where the first object A meets none of the obstacle objects and the first object A coincides with the second object B, it is determined that the living body detection is successful. Preferably, in a case where the first object A meets none of the obstacle objects within a predetermined time period and the first object A coincides with the second object B, it is determined that the living body detection is successful.

For example, in a case where the predetermined condition is that the first object A does not meet a predetermined number of obstacle objects, it may be determined in step S550 whether the first object A meets a currently displayed obstacle object, whether the currently displayed obstacle object has moved out of the display screen, and whether the number of obstacle objects that have been displayed has reached a predetermined number. If it is determined in step S550 that the first object A does not meet the currently displayed obstacle object and the currently displayed obstacle object moves out of the display screen and the number of already-displayed obstacle objects does not reach the predetermined number, a new obstacle object is displayed on the display screen, and the processing returns to step S520. If it is determined in step S550 that the first object A does not meet the currently displayed obstacle object and the currently displayed obstacle object is still displayed on the display screen, the processing returns to step S520. If it is determined in step S550 that the first object A meets the currently displayed obstacle object, it is determined in step S570 that no face of a living body has been detected. If it is determined in step S550 that the first object A does not meet the currently displayed obstacle object and the currently displayed obstacle object moves out of the display screen and the number of already-displayed obstacle objects reaches a predetermined number, it is determined in step S560 that a face of a living body has been detected.

### Second Example

In the second example, at least one object in the second group of objects is displayed according to display situation of at least one object in the first group of objects. Optionally, at least one other object in the second group of objects is further displayed according to display situation of at least one object in the second group of objects. Objects in the second group of objects are non-controlled objects, that is, background objects, and the background objects are obstacle objects.

Specifically, the first group of objects includes a first object and a second object, displaying of the first object and the second object on the display screen is updated according to the detected facial motion. Specifically, the vertical display position of the first object is fixed, and the horizontal display position of the first object and the horizontal and vertical display positions of the second object are updated according to the detected facial motion.

Optionally, an obstacle object in the second group of objects is also displayed according to display situation of the second object, and a new obstacle object in the second group of objects may also be displayed according to display situation of said obstacle object in the second group of objects. Specifically, the horizontal display position of the first object and the horizontal and vertical display positions of the obstacle object in the second group of objects are updated according to the detected facial motion.

The facial motion attribute may include a first motion attribute and a second motion attribute, a state parameter of the first object includes first and second state parameters of the first object, the first state parameter and the second state parameter of the first object are a traveling parameter and a horizontal position of the first object, respectively, and the traveling parameter may be a moving speed, a traveling distance, or the like. For example, in a case where the travel parameter is a motion speed, first, the value of the motion speed of the first object is updated according to the value of the first motion attribute, and the value of the horizontal position coordinate of the first object is updated according to the value of the second motion attribute. Next, the display positions of the obstacle object D and the first object A are determined according to the value of the motion speed of the first object A, the distance (which may include the horizontal distance and the vertical distance) between the first object A and the obstacle object D, and the horizontal position coordinate of the first object A. For example, in a case where a target heading direction of the first object is a road extending direction (the direction in which the road narrows in FIG. 10C) and the vertical display position of the first object A remains unchanged, it may determine whether continue to display the obstacle object D and the display position of the obstacle object D according to the value of the motion speed of the first object A and the vertical distance between the first object A and the obstacle object D, the display position of the first object A may be determined according to the horizontal position coordinate of the first object A.

Specifically, for example, the first object A may be a car, the obstacle D may be a randomly generated stone on a road on which the car is traveling, and the first motion attribute may be the degree of face tilting, and the second motion attribute may be the degree of face deflection, and the first state parameter and the second state parameter of the first object A may be the motion speed and the horizontal position of the first object, respectively. For example, the state of face looking at the front horizontally may correspond to a motion speed V0, the state of face looking up 30 or 45 degrees may correspond to a maximum motion speed VH, the state of face looking down 30 or 45 degrees may correspond to a minimum motion speed VL, the motion speed of the first object may be determined according to the value of the degree of face tilting (e.g., the angle of face looking up or looking down). For example, the state of face looking squarely may correspond to a middle position P0, the state of face deflecting leftward 30 degrees or 45 degrees corresponds to a left-side edge position PL, and the state of face deflecting rightward 30 degrees or 45 degrees corresponds to a right-side edge position PR, the horizontal position coordinate of the first object is determined according to the value of the degree of face deflection (for example, the face deflection angle).

In addition, the state parameter of the first object further includes a third state parameter of the first object, and the third state parameter may be a traveling distance of the first object. Optionally, in a case where the first object does not meet the obstacle object and the traveling distance of the first object within a predetermined time period reaches a preset distance value, it is determined that the living body detection is successful.

Specific implementations of the living body detection method according to an embodiment of the present disclosure have been described above in the first to fourth embodiments. It should be understood that various specific operations in the first to the fourth embodiments may be combined as needed.

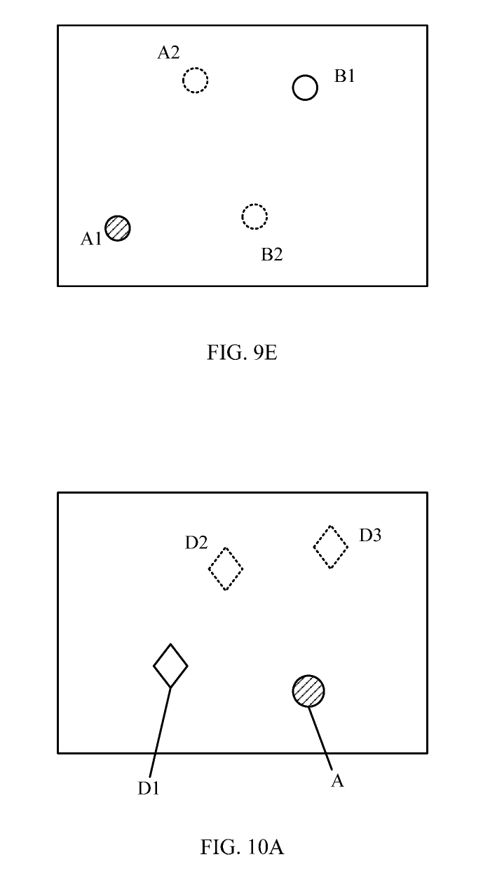

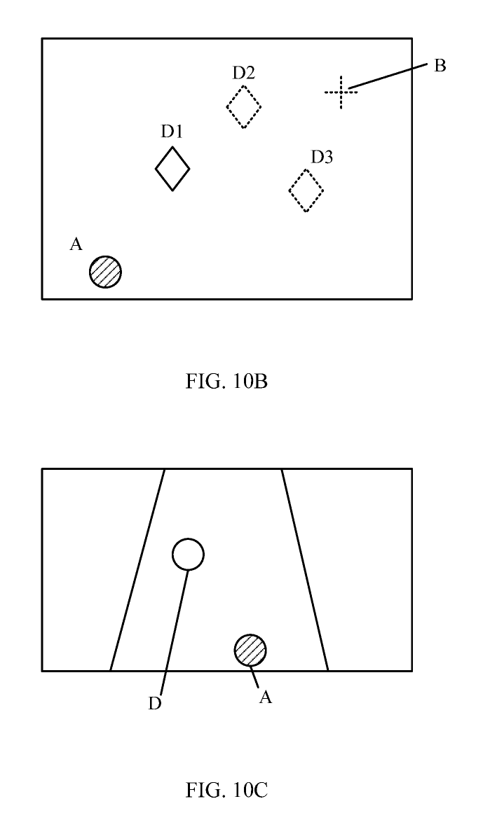

Hereinafter, a living body detection apparatus according to an embodiment of the present disclosure will be described with reference to FIGS. 11 and 12. The living body detection device may be an electronic device integrated with a facial image capture device, such as a smart phone, a tablet, a personal computer, an ID recognition device based on face recognition, or the like. Alternatively, the living body detection apparatus may further include a separate face image capture device and a detection processing device, the detection processing device may receive a captured image from the face image capture device and perform living body detection according to the received captured image. The detection processing device may be a server, a smart phone, a tablet computer, a personal computer, a face recognition-based identification device, or the like.

Since details of the various operations performed by the living body detection apparatus are substantially the same as those of the living body detection method described above with respect to FIGS. 2-4, in order to avoid repetition, the living body detection apparatus will be briefly described below, the same details are omitted.

As shown in FIG. 11, the living body detection apparatus 1100 according to an embodiment of the present disclosure includes a facial motion detection device 1110, a virtual object control device 1120, and a living body determining device 1130. The facial motion detection device 1110, the virtual object control device 1120, and the living body determining device 1130 may be implemented by the processor 102 shown in FIG. 1.

As shown in FIG. 12, the living body detection apparatus 1200 according to an embodiment of the present disclosure includes an image capture device 1240, a facial motion detection device 1110, a virtual object control device 1120, a living body determining device 1130, a display device 1250, and a storage device 1260. The image capture device 1240 may be implemented by the image capture device 110 shown in FIG. 1. The facial motion detection device 1110, the virtual object control device 1120, and the living body determining device 1130 may be implemented by the processor 102 shown in FIG. 1. The display device 1250 maybe implemented by the output device 108 shown in FIG. 1, and the storage device 1260 can be implemented by the storage device 104 shown in FIG. 1.

A grayscale or chromatic image within a predetermined shooting range may be captured by using the image capture device 1240 in the living body detection device 1200 or other image capture devices independent of the living body detection device 1100 or 1200 but capable of transmitting images to the living body detection device 1100 or 1200 as a captured image, the captured image may be a photo or one frame of in a video. The image capture device may be a camera of a smart phone, a camera of a tablet, a camera of a personal computer, or even a webcam.

The facial motion detection device 1110 is configured to detect a facial motion from the captured image.

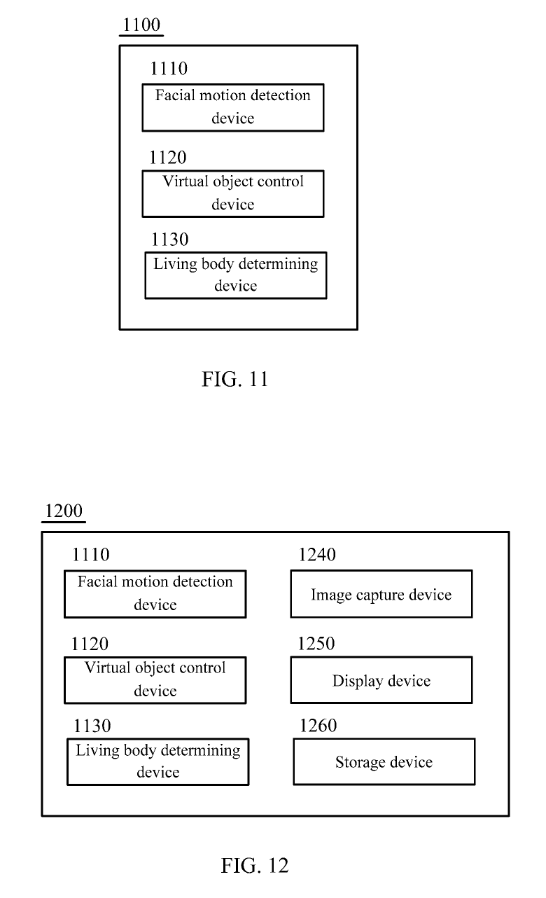

As shown in FIG. 13, the facial motion detection device 1110 may include a landmark positioning device 1310, a texture information extraction device 1320, and an motion attribute determining device 1330.

The landmark positioning device 1310 is configured to position face landmarks in the captured image. As an example, the landmark point positioning device 1310 may first determine whether a face is included in the acquired image, and position face landmarks if a face has been detected. Details of the operation of the landmark point positioning device 1310 are the same as those described in step S310, details are omitted herein.

The texture information extraction device 1320 is configured to extract image texture information from the captured image. As an example, the texture information extracting device 1320 may extract fine-grained facial information, such as eyeball position information, mouth shape information, micro facial expression information, or the like, according to pixel information in the captured image, such as luminance information of pixel dots.

The motion attribute determining module 1330 obtains the value of the facial motion attribute based on the positioned face landmarks and/or the image texture information. The facial motion attribute obtained based on the positioned facial landmarks may, for example, include, but not limited to, a degree of eye opening and closing, a degree of mouth opening and closing, a degree of face tilting, a degree of face deflection, a distance between face and camera, or the like. The facial motion attribute obtained based on the image texture information may include, but not limited to, a degree of leftward and rightward eyeball rotation, a degree of upward and downward eyeball rotation, or the like. Details of the operation of the motion attribute determining device 1330 are the same as those described in step S330, details are omitted herein.

The virtual object control device 1120 is configured to display a virtual object on the display device 1250 according to the detected facial motion.

As an example, the state of the virtual object displayed on the display screen may be controlled to change according to the detected facial motion. In this case, the virtual object may include a first group of objects that has been displayed on the display screen in an initial state and may include one or more objects. In this example, displaying of at least one object in the first group of objects on the display screen is updated based on the detected facial motion. An initial display position and/or an initial display form of at least part of the objects in the first group of objects is predetermined or randomly determined. Specifically, for example, the motion state, the display position, the size, the shape, the color, or the like of the virtual object may be changed.

Optionally, a new virtual object may be controlled to display on the display screen according to the detected facial motion. In this case, the virtual object may further include a second group of objects that has not been displayed on the display screen in an initial state and may include one or more objects. In this example, at least one object in the second group of objects is displayed according to the detected facial motion. An initial display position and/or an initial display form of at least a portion of the at least one object of the second group of objects is predetermined or randomly determined.

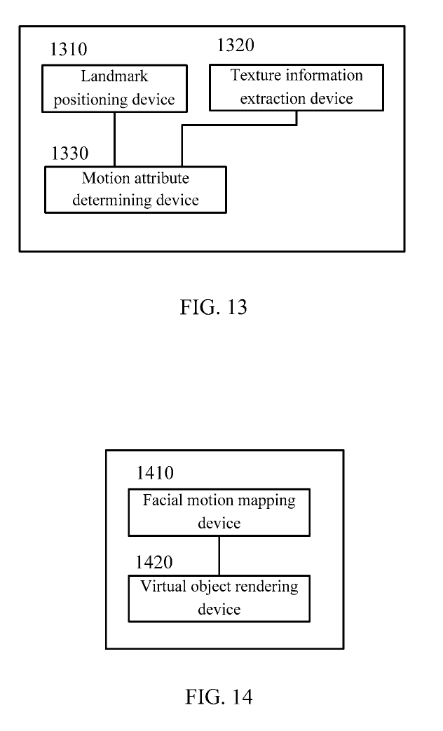

As shown in FIG. 14, the virtual object control device 1120 may include a facial motion mapping device 1410 and a virtual object rendering device 1420.

The facial motion mapping device 1410 updates the value of the state parameter of the virtual object according to the value of the facial motion attribute.

Specifically, one facial motion attribute may be mapped as one state parameter of the virtual object. For example, the degree of eye opening and closing or the degree of mouth opening and closing of the user may be mapped as the size of the virtual object, and the size of the virtual object may be updated according to a value of the degree of eye opening and closing or a value of the degree of mouth opening and closing of the user. Another example, the degree of face tilting of the user may be mapped as a vertical display position of the virtual object on the display screen, and the vertical display position of the virtual object on the display screen is updated according to a value of the degree of face tilting of the user. Optionally, mapping relationship between the facial motion attribute and the state parameter of the virtual object may be preset.

For example, the facial motion attribute may include at least one motion attribute, and the state parameter of the virtual object includes at least one state parameter. One motion attribute may correspond to only one state parameter, or one motion attribute may correspond to a plurality of state parameters in a chronological order.

The virtual object rendering device 1420 renders the virtual object according to the updated value of the state parameter of the virtual object.

Specifically, the virtual object rendering device 1420 may update displaying of at least one object in the first group of objects. Advantageously, the virtual object rendering device 1420 may further display a new virtual object, that is, a virtual object in the second group of objects. Advantageously, the virtual object rendering device 1420 may also update displaying of at least one object in the second group of objects.

The living body determining device 1130 is configured to determine whether the virtual object satisfies a predetermined condition, and determine that a face in the captured image is a face of a living body in a case where it is determined that the virtual object satisfies the predetermined condition. The predetermined condition is a condition related to a shape and/or a motion of the virtual object, wherein the predetermined condition is predetermined or randomly generated.

Specifically, it may be determined whether the form of the virtual object satisfies a form-related condition. For example, the form of the virtual object may include a size, a shape, a color, or the like; and it may be determined whether a motion-related parameter of the virtual object satisfies a motion-related condition, for example, the motion-related parameter of the virtual object may include a position, a motion trajectory, a motion speed, a motion direction, or the like, and the motion-related condition may include a predetermined display position of the virtual object, a predetermined motion trajectory of the virtual object, a predetermined display position that the display position of the virtual object needs to be avoided from, or the like. It may be determined whether the virtual object has completed a predetermined task according to an actual motion trajectory of the virtual object. The predetermined task may include, for example, moving along a predetermined motion trajectory, moving around an obstacle, or the like.

For example, in a case where the virtual object includes a first object, the predetermined condition may be set as that the first object reaches a target display position, the first object reaches a target display size, the first object reaches a target shape, and/or the first object reaches a target display color, and so on.

Optionally, the first group of objects further includes a second object, an initial display position and/or an initial display form of at least one of the first object and the second object is predetermined or randomly determined. As an example, the first object may be a controlled object, the second object may be a background object, and optionally, the second object may be a target object of the first object, and the predetermined condition may be set as that the first object coincides with the target object. Alternatively, the background object may be a target motion trajectory of the first object, the target motion trajectory may be randomly generated, the predetermined condition may be set as that an actual motion trajectory of the first object coincides with the target motion trajectory. Alternatively, the background object may be an obstacle object, and the obstacle object may be randomly displayed, its display position and display time are both random, and the predetermined condition may be set as that the first object does not meet the obstacle object, i.e. the first object bypasses the obstacle object.

Another example, in a case where the virtual object further includes a second group of objects and the second group of objects includes a third object as a controlled object, the predetermined condition may further be set as that the first and/or the third object reaches the corresponding target display position, the first and/or the third object reaches the corresponding target display size, the first and/or the third object reaches the corresponding target shape, and the first and/or the third object reaches the corresponding target display color, and so on.

Another example, in a case where the virtual object includes the first object and the second object, the predetermined condition may be set as follows: the first object reaches the target display position, the first object reaches the target display size, the first object reaches the target shape, and/or the virtual object reaches the target display color, or the like, and the second object reaches the target display position, the second object reaches the target display size, and the second object reaches the target shape, and/or the second object reaches a target display color, and so on.

The facial motion mapping device 1410 and the virtual object rendering device 1420 may perform various operations in the first to fifth embodiments, and details are omitted herein.

In addition, the living body detection devices 1100 and 1200 according to an embodiment of the present disclosure may further include a timer for counting a predetermined timing period. The timer may also be implemented by the processor 102. The timer may be initialized according to a user input, or may be automatically initialized when a face has been detected in the captured image, or may be automatically initialized when a predetermined facial motion has been detected in the captured image. In this case, the living body determining device 1130 is configured to determine whether the virtual object satisfies a predetermined condition within the predetermined timing period, and determine that the face in the captured image is a face of a living body in a case where it is determined that the virtual object satisfies the predetermined condition within the predetermined timing period.

The storage device 1260 is configured to store the captured image. In addition, the storage 1260 is further configured to store the state parameter and the value of the state parameter of the virtual object. In addition, the storage device 1260 is further configured to store the virtual object rendered by the virtual object rendering device 1420 and store a background image to be displayed on the display device 1250, or the like.

In addition, the storage device 1260 may store computer program instructions that can implement the living body detection method according to an embodiment of the present disclosure when being run by the processor 102, and/or may implement the landmark locating device 1310, the texture information extracting device 1320, and the motion attribute determining device 1330 in the living body detection apparatus according to an embodiment of the present disclosure.

In addition, according to an embodiment of the present disclosure, there is also provided a computer program product comprising a computer-readable storage medium on which computer program instructions are stored. The computer program instructions, when being executed by a computer, may implement the living body detection method according to an embodiment of the present disclosure and/or may implement all or part of the functions of the landmark locating device, the texture information extracting device, and the motion attribute determining device according to an embodiment of the present disclosure.

The living body detection method, the living body detection apparatus, and the computer program product according to the embodiments of the present disclosure can, by means of controlling to display the virtual object based on the facial motion and performing living body detection according to displaying of the virtual object, effectively prevent attacks using photos, videos, 3D face models, or masks, and so on, without depending on special hardware devices, thereby reduce the cost of living body detection. Further, a plurality of state parameters of the virtual object can be controlled by recognizing a plurality of motion attributes in the facial motion, so as to cause the virtual object to change a display state in multiple aspects, for example, causing the virtual object to perform a complicated predetermined motion, or causing the virtual object to achieve a display effect very different from an initial display effect. Therefore, the accuracy of living body detection can be further improved, thereby security in scenarios where the living body detection method, the living body detection apparatus, and the computer program product according to the embodiments of the present disclosure are applied can be further enhanced.

The computer readable storage medium may be any combination of one or more computer readable storage mediums. The computer readable storage medium may, for example, include a memory card of a smart phone, a storage unit of a tablet computer, a hard disk of a personal computer, a random access memory (RAM), a read only memory (ROM), an erasable programmable read-only memory (EPROM), a portable compact disc read-only memory (CD-ROM), a USB memory, or a combination of any the aforesaid storage mediums.

Exemplary embodiments of the present disclosure as described in detail in the above are merely illustrative, rather than limitative. However, those skilled in the art should understand that various modifications, combinations or sub-combinations may be made to these embodiments without departing from the principles and spirits of the present disclosure, and such modifications are intended to fall within the scope of the present disclosure.

1. A living body detection method, comprising:
detecting a facial motion from a captured image;
controlling to display a virtual object on a display screen according to the detected facial motion; and
determining that a face in the captured image is a face of a living body in a case where the virtual object satisfies a predetermined condition.

2. The living body detection method as claimed in claim 1, further comprising:
capturing in real time a first image within a predetermined shooting range as the captured image;
wherein the living body detection method further comprises capturing in real time a second image within the predetermined shooting range as the captured image in a case where the virtual object does not satisfy the predetermined condition.

3. The living body detection method as claimed in claim 1, wherein the predetermined condition is a condition related to a form and/or a motion of the virtual object, the predetermined condition is predetermined or randomly generated.

4. The living body detection method as claimed in claim 1, wherein the virtual object includes a first group of objects that has been displayed on the display screen and includes one or more objects,
wherein controlling to display a virtual object on a display screen according to the detected facial motion comprises updating displaying of at least one object in the first group of objects on the display screen according to the detected facial motion, wherein the at least one object in the first group of objects is a controlled object,
wherein an initial display position and/or an initial display form of at least part of objects in the first group of objects is predetermined or randomly determined.

5. The living body detection method as claimed in claim 1, wherein the virtual object includes a second group of objects that has not been displayed on the display screen and includes one or more objects,
wherein controlling to display a virtual object on a display screen according to the detected facial motion further comprises displaying at least a portion of at least one object in the second group of objects according to the detected facial motion,
wherein an initial display position and/or an initial display form of at least a portion of at least one object in the second group of objects is predetermined or randomly determined.

6. The living body detection method as claimed in claim 1, wherein it is determined that a face in the captured image is a face of a living body in a case where the virtual object satisfies a predetermined condition within a predetermined time period.

7. The living body detection method as claimed in claim 1, wherein detecting a facial motion from a captured image comprises:
positioning facial landmarks in the captured image, and/or extracting image texture information from the captured image; and
obtaining a value of a facial motion attribute based on the positioned facial landmarks and/or the extracted image texture information.

8. The living body detection method as claimed in claim 7, wherein controlling to display a virtual object on a display screen according to the detected facial motion comprises:
updating a value of a state parameter of the virtual object according to the value of the facial motion attribute of the detected facial motion; and
displaying the virtual object on the display screen according to the updated value of the state parameter of the virtual object.

9. The living body detection method as claimed in claim 7, wherein the facial motion attribute includes at least one of: a degree of eye opening and closing, a degree of mouth opening and closing, a degree of face tilting, a degree of face deflection, a distance between face and camera, a degree of leftward and rightward eyeball rotation, and a degree of upward and downward eyeball rotation.

10. A living body detection apparatus, comprising:
one or more processors;
one or more memories; and
computer program instructions stored in the memories and configured to execute the following steps when being run by the processors: detecting a facial motion from a captured image; controlling to display a virtual object on a display device according to the detected facial motion; and determining that a face in the captured image is a face of a living body in a case where the virtual object satisfies a predetermined condition.

11. The living body detection apparatus as claimed in claim 10, further comprising:
an image capture device for capturing in real time a first image within a predetermined shooting range as the captured image; and
the display device,
wherein the image capture device further captures in real time a second image within the predetermined shooting range as the captured image in a case where the virtual object does not satisfy the predetermined condition.

12. The living body detection apparatus as claimed in claim 10, wherein the predetermined condition is a condition related to a form and/or a motion of the virtual object, the predetermined condition is predetermined or randomly generated.

13. The living body detection apparatus as claimed in claim 10, wherein the virtual object includes a first group of objects that has been displayed on the display device and includes one or more objects,
wherein controlling to display a virtual object on a display device according to the detected facial motion comprises updating displaying of at least one object in the first group of objects on the display device according to the detected facial motion, wherein the at least one object in the first group of objects is a controlled object,
wherein an initial display position and/or an initial display form of at least part of objects in the first group of objects is predetermined or randomly determined.

14. The living body detection apparatus as claimed in claim 13, wherein the virtual object includes a second group of objects that has not been displayed on the display device and includes one or more objects,
wherein controlling to display a virtual object on a display device according to the detected facial motion further comprises displaying at least a portion of at least one object in the second group of objects according to the detected facial motion,
wherein an initial display position and/or an initial display form of at least a portion object of at least one object in the second group of objects is predetermined or randomly determined.

15. The living body detection apparatus as claimed in claim 13, wherein the computer program instructions are configured to execute the following step when being run by the processors: initializing a timer;
wherein determining that a face in the captured image is a face of a living body in a case where the virtual object satisfies a predetermined condition comprises: determining that a face in the captured image is a face of a living body in a case where the virtual object satisfies a predetermined condition while the timer does not exceed a predetermined timing period.

16. The living body detection apparatus as claimed in claim 13, wherein detecting a facial motion from a captured image comprises:
positioning facial landmarks in the captured image, and/or extracting image texture information from the captured image; and
obtaining a value of a facial motion attribute based on the positioned facial landmarks and/or the extracted image texture information, wherein the facial motion attribute including at least one motion attribute.

17. The living body detection apparatus as claimed in claim 16, wherein controlling to display a virtual object on a display device according to the detected facial motion comprises:
updating a value of a state parameter of the virtual object according to the value of the facial motion attribute of the detected facial motion; and
displaying the virtual object on the display screen according to the updated value of the state parameter of the virtual object.

18. A computer program product, comprising one or more non-transitory computer readable storage mediums having stored thereon computer program instructions configured to execute the following steps when being run by a computer:
detecting a facial motion from a captured image;
controlling to display a virtual object on a display device according to the detected facial motion; and
determining that a face in the captured image is a face of a living body in a case where the virtual object satisfies a predetermined condition.

19. The computer program product as claimed in claim 18, wherein the predetermined condition is a condition related to a form and/or a motion of the virtual object, the predetermined condition is predetermined or randomly generated.

20. The computer program product as claimed in claim 18, wherein the detected facial motion is represented by a value of a facial motion attribute, the facial motion attribute includes at least one motion attribute,
controlling to display a virtual object on a display device according to the detected facial motion comprises:
updating a value of a state parameter of the virtual object according to the value of the facial motion attribute of the detected facial motion; and
displaying the virtual object on the display screen according to the updated value of the state parameter of the virtual object.
